(19) United States
(12) Patent Application Publication
(10) Pub. No.: US 2025/0096357 A1
(43) Pub. Date: Mar. 20, 2025

(54) MULTI-FUNCTION BEAM WITH INTEGRATED STRUCTURAL, COOLING, AND TRANSVERSE ELASTIC COMPLIANCE FUNCTIONS FOR USE WITH ELECTRIC VEHICLE BATTERY PACKS

(71) Applicant: GM GLOBAL TECHNOLOGY OPERATIONS LLC, Detroit, MI (US)

(72) Inventors: Lu Huang, Troy, MI (US); Hui-ping Wang, Troy, MI (US); Chengwu Duan, Shanghai (CN); Derek F. Lahr, Ann Arbor, MI (US); Zhenwen Hu, Shanghai (CN); Jian Yao, Shanghai (CN); Blair E. Carlson, Ann Arbor, MI (US); Xiaoling Chen, Sterling Heights, MI (US)

(73) Assignee: GM GLOBAL TECHNOLOGY OPERATIONS LLC, Detroit, MI (US)

(21) Appl. No.: 18/499,726

(22) Filed: Nov. 1, 2023

(30) Foreign Application Priority Data
Sep. 15, 2023 (CN) 202311197952.2

(51) Int. Cl. H01M 10/6557; B60L 50/64; H01M 10/613; H01M 10/625; H01M 10/6555; H01M 50/209; H01M 50/249; H01M 50/581

(52) U.S. Cl. CPC H01M 10/6557; B60L 50/64; H01M 10/613; H01M 10/625; H01M 10/6555; H01M 50/209; H01M 50/249; H01M 50/581; H01M 2200/103; H01M 2220/20

(57) ABSTRACT

The present disclosure describes a multi-function, integrated Super Beam assembly structure with integrated structural, cooling, and transverse elastic compliance functions; and Thermal Management Propagation (TMP) protection. The Super Beam assembly includes a pair of parallel face plates, coolant channel cover plates, and coolant channels that are defined by the face plate and the one or more coolant channel cover plates. The structural design of the cooling channels, and the corresponding air gaps formed in-between them, allows a transverse elastic compliance of the Super Beam assembly to be tuned to different amounts of elasticity. Top, bottom and/or end structural channels may be included. A pair of TMP suppression channels may be attached to the Super Beam assembly structure with an adhesive “thermal fuse” that preferentially melts and causes the pair of TMP suppression channels to detach from the Super Beam assembly during overheating in a TMP event.

### CROSS-REFERENCE TO RELATED APPLICATIONS

This application claims priority to and the benefit of Chinese Patent Application No. 202311197952.2, which was filed on Sep. 15, 2023, and which is hereby incorporated by reference in its entirety.

### INTRODUCTION

The present disclosure relates to structural support beams and thermal cooling plates for use with rechargeable battery packs in electric vehicles. More specifically, aspects of this disclosure relate to multi-function, integrated structural support beams with internal cooling channels and tunable transverse elastic compliance, and further including protection against Thermal Management Propagation (TMP) events.

In Rechargeable Energy Storage Systems (RESS) designs, stand-alone, individual components are used to achieve different functionalities within the battery pack. For example, a few thick and rigid cross beams are used for structural integrity. Separate cooling plates are used to maintain the battery cell temperature. Finally, aero gels or other elastic (compliant) materials are used to facilitate transverse pre-compression and accommodate transverse expansion of the battery cells during charging and recharging cycles. These individual components take up precious space in the battery pack, resulting in a decrease in overall battery pack energy density. Thermal Management Propagation (TMP) refers to a situation where the temperature of one battery cell increases rapidly and causes the temperature of an adjacent battery cell to also increase rapidly.

### SUMMARY

A “Super Beam” assembly, as contemplated herein, provides an integrated solution that combines structural support beams with internal cooling channels and tunable transverse elastic compliance, in a single, integrated, multi-function structure, including protection against TMP events.

In one or more implementations, the Super Beam assembly includes a pair of parallel face plates, one or more coolant channel cover plates, and one or more coolant channels that are defined by the face plate and the one or more coolant channel cover plates. The structural design of the cooling channels, and the corresponding air gaps formed in-between them, allows a transverse elastic compliance of the Super Beam assembly to be tuned to different amounts of elasticity. Optional top, bottom and/or end structural channels provide enhanced load bearing capability.

In one example, a pair of TMP suppression channels may be attached to the Super Beam assembly structure with an adhesive “thermal fuse” that preferentially melts and causes the pair of TMP suppression channels to detach from the Super Beam assembly during overheating in a TMP event.

The multi-function Super Beam assembly may further include a left coolant inlet disposed at a proximal end of the left face plate; a left coolant outlet disposed at a distal end of the left face plate; a right coolant inlet disposed at a proximal end of the right face plate; and a right coolant outlet disposed at a distal end of the right face plate. The left coolant channel may have a C-shaped cross-section, and the right coolant channel has a C-shaped cross-section.

In an example, the multi-function Super Beam assembly may have a left battery cell disposed adjacent to the left face plate, and a right battery cell disposed adjacent to the right face plate. In another embodiment, a left thermal interface material (TIM) may be disposed in-between the left battery cell and the left face plate; and a right TIM material may be disposed in-between the right battery cell and the right face plate.

The Super Beam assembly may further include a top structural channel that is attached to the left face plate and to the right face plate. The top structural channel may be attached to an upper left extension of the left face plate; and also may be attached to an upper right extension of the right face plate. The top structural channel may have a T-shaped or a M-shaped cross-section.

In an example, the multi-function Super Beam assembly may further include an upper left flange integrally attached to the left face plate; and an upper right flange integrally attached to the right face plate; wherein the top structural channel is attached to the upper left flange and the upper right flange. The top structural channel may be adhesively attached to the left upper flange with a left adhesive strip; and may be adhesively attached to the right upper flange with a right adhesive strip.

In another embodiment, the multi-function Super Beam assembly may further include a bottom structural channel that is attached to the left face plate; and the bottom structural channel is attached to the right face plate. The bottom structural channel may have an I-shaped cross-section. In another example, a left bottom portion of the left face plate may have a Zig-Zag shaped cross-section; and a right bottom portion of the right face plate may have a Zig-Zag shaped cross-section.

In an example, the multi-function Super Beam assembly further includes: an upper air gap disposed in-between the left face plate and the right face plate; and a lower air gap disposed in-between the left face plate and the right face plate.

In one or more embodiments, the top structural channel and the bottom structural channel may have a width that is less than or equal to a width of a battery cell.

In an example, a Super Beam assembly further includes a top thermal management propagation (TMP) suppression channel attached to a top portion of the Super Beam assembly; and a bottom TMP suppression channel attached to a bottom portion of the Super Beam assembly.

The Super Beam assembly may further include a left upper flange integrally attached to the left face plate; a right upper flange integrally attached to the right face plate; a left lower flange integrally attached to the left face plate; a right lower flange integrally attached to the right face plate; a left upper thermal fuse disposed between the top TMP suppression channel and the left upper flange; a right upper thermal fuse disposed between the top TMP suppression channel and the right upper flange; a left lower thermal fuse disposed between the top TMP suppression channel and the left lower flange; and a right lower thermal fuse disposed between the top TMP suppression channel and the right lower flange.

In some embodiments, the top TMP suppression channel may include a plurality of upper Z-fold bellows segments; and the bottom TMP suppression channel comprises a plurality of lower Z-fold bellows segments.

Finally, in an implementation, an electric vehicle may include an electric motor vehicle body; a battery pack connected to the electric motor vehicle body; and a plurality of integrated Super Beam assemblies disposed inside of the battery pack; wherein each Super Beam assembly includes: a left face plate; a right face plate; a one or more right coolant channel cover plates; one or more right coolant channel cover plates; one or more left coolant channels defined by the left face plate and by the one or more left coolant channel cover plates; and one or more right coolant channels defined by the right face plate and by the one or more right coolant channel cover plates; and wherein the left face plate is oriented parallel to the left face plate.

### BRIEF DESCRIPTION OF THE DRAWINGS

FIG. 1 shows a schematic perspective view of an example of a battery pack for an electric vehicle with five, large structural cross-beams spanning across the width of the battery pack.

FIG. 2 shows a schematic perspective view of an example of a battery pack for an electric vehicle with a plurality of multi-function Super Beam assemblies located in-between pairs of adjacent battery cells, according to the present disclosure.

FIG. 3A shows a schematic perspective view of an example of a one-half section of a Super Beam assembly with integrated structural, cooling, and transverse elastic compliance functions, according to the present disclosure.

FIG. 3B shows a schematic cross-section elevation (end) view (Section A-A) of an example of a one-half section of a Super Beam assembly with integrated structural, cooling, and transverse elastic compliance functions, according to the present disclosure.

FIG. 4 shows a schematic cross-section elevation (end) view (Section A-A) of an example of a complete Super Beam assembly with integrated structural, cooling, and transverse elastic compliance functions, and top and bottom structural channels, according to the present disclosure.

FIG. 5 shows a schematic cross-section elevation (end) view (Section D-D) of an example of a complete Super Beam assembly with integrated structural, cooling, and transverse elastic compliance functions, and top and bottom structural channels, according to the present disclosure.

FIG. 6 shows a schematic cross-section elevation (end) view (Section A-A) of an example of a top structural channel, according to the present disclosure.

FIG. 7 shows a schematic perspective view of an example of one-half 14 a Super Beam assembly with integrated structural, cooling, and transverse elastic compliance functions, and four integral flange sections, according to the present disclosure.

FIG. 8 shows a schematic cross-section elevation (end) view (Section A-A) of an example of a Super Beam assembly with integrated structural, cooling, and transverse elastic compliance functions, and two pairs of longitudinal integral flanges attached to each face plate, respectively, according to the present disclosure.

FIG. 9 shows a schematic exploded perspective view of an example of two, one-half sections of a Super Beam assembly with integrated structural, cooling, and transverse elastic compliance functions, and integral perimeter flanges, and a top structural channel, according to the present disclosure.

FIG. 10 shows a schematic cross-section elevation (end) view (Section A-A) of an example of a Super Beam assembly with integrated structural, cooling, and transverse elastic compliance functions, according to the present disclosure.

FIG. 11 shows a schematic cross-section elevation (end) view (Section A-A) of an example of a Super Beam assembly with integrated structural, cooling, and transverse elastic compliance functions, according to the present disclosure.

FIG. 12 shows a schematic cross-section elevation (end) view (Section A-A) of an example of a Super Beam assembly with integrated structural, cooling, and transverse elastic compliance functions, according to the present disclosure.

FIG. 13 shows a schematic cross-section elevation (end) view (Section A-A) of an example of a Super Beam assembly with integrated structural, cooling, and transverse elastic compliance functions, according to the present disclosure.

FIG. 14 shows a schematic perspective cross-sectional elevation (side) view (Section C-C) of an example of a Super Beam assembly with integrated structural, cooling, and transverse elastic compliance functions, and top and bottom structural channels, and a pair of perpendicular frame enclosure beams, according to the present disclosure.

FIG. 15 shows a schematic cross-section elevation (end) view (Section A-A) of an example of a Super Beam assembly with integrated structural, cooling, and transverse elastic compliance functions, and top and bottom structural channels, according to the present disclosure.

FIG. 16 shows a schematic cross-section elevation (end) view (Section A-A) of an example of a top structural channel, according to the present disclosure.

FIG. 17 shows a schematic cross-section elevation (end) view (Section A-A) of an example of a Super Beam assembly face plate with a pair of vertical extensions, according to the present disclosure.

FIG. 18 shows a schematic cross-section elevation (end) view (Section A-A) of an example of a Super Beam assembly face plate with integral perimeter top and bottom flanges, according to the present disclosure.

FIG. 19 shows a schematic cross-section elevation (end) view (Section A-A) of an example of a Super Beam assembly face plate with integral top and bottom perimeter flanges, according to the present disclosure.

FIG. 20 shows a schematic cross-section elevation (end) view (Section A-A) of an example of a Super Beam assembly with integrated structural, cooling, and transverse elastic compliance functions, and top and bottom structural channels, according to the present disclosure.

FIG. 21 shows a schematic cross-section elevation (end) view (Section A-A) of an example of a Super Beam assembly with integrated structural, cooling, and transverse elastic compliance functions, and top and bottom structural channels, according to the present disclosure.

FIG. 22 shows a schematic cross-section plan (top) view (Section B-B) of an example of one-half of a Super Beam assembly with integrated structural, cooling, and transverse elastic compliance functions, and integral perimeter flanges, according to the present disclosure.

FIG. 23 shows a schematic perspective view of an example of an electric vehicle with an integrated battery pack, according to the present disclosure.

FIG. 24 shows a schematic perspective view of an example of a complete Super Beam assembly with a full complement of adjacent battery cells, according to the present disclosure.

FIG. 25A shows a schematic side elevation view of an example of a pair of vertical end structural channels that are attached to proximal and distal ends of a Super Beam assembly, according to the present disclosure.

FIG. 25B shows a schematic plan (top) cross-section view (Section B-B) of an example of a pair of vertical end structural channels attached to proximal and distal ends of a Super Beam assembly, according to the present disclosure.

FIG. 26 shows a schematic cross-section view (Section A-A) of an example of four Super Beam assemblies with five adjacent battery cells, according to the present disclosure.

FIG. 27 shows a schematic perspective of an example of seven Super Beam assemblies holding thirty-two battery cells, arranged in seven parallel rows in a battery pack assembly, according to the present disclosure.

FIG. 28 shows a schematic cross-section view (Section A-A) of an example of a Super Beam assembly holding two battery cells, with top and bottom TMP suppression channels, according to the present disclosure.

FIG. 29A shows a schematic cross-section view (Section A-A) of an example of a top TMP suppression channel, according to the present disclosure.

FIG. 29B shows a schematic cross-section view (Section A-A) of an example of a top TMP suppression channel with a pair of four Z-fold bellows segments, according to the present disclosure.

FIG. 30 shows a schematic perspective cross-section view (Section A-A) of an example of a top TMP suppression channel with a series of slots, according to the present disclosure.

FIG. 31 shows a schematic perspective cross-section view (Section A-A) of an example of a top TMP suppression channel with a series of multiple perforations, according to the present disclosure.

FIG. 32 shows a schematic perspective cross-section view (Section A-A) of an example of a top TMP suppression channel with a central groove, according to the present disclosure.

FIG. 33 shows a schematic perspective view of a battery pack frame enclosure with a single Super Beam assembly oriented longitudinally (side-to-side) along the X-direction, according to the present disclosure.

FIG. 34 shows a schematic perspective view of a battery pack frame enclosure with a single Super Beam assembly oriented longitudinally (front-to-back) along the Y-direction, according to the present disclosure.

### DETAILED DESCRIPTION

This disclosure includes examples in many different forms. Representative examples of the disclosure are shown in the drawings and will herein be described in detail with the understanding that these examples are provided as an exemplification of the disclosed principles, not limitations of the broad aspects of the disclosure. To that extent, elements and limitations that are described, for example, in the Abstract, Introduction, Summary, and Detailed Description sections, but not explicitly set forth in the claims, should not be incorporated into the claims, singly or collectively, by implication, inference, or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example.

Unless specifically stated from context, as used herein, the term “about” is understood as within a range of normal tolerance in the art, for example within 2 standard deviations of the mean. “About” may be understood as within 10%, 5%, 1%, 0.5%, 0.1%, 0.05%, or 0.01% of the stated value. “About” may alternatively be understood as implying the exact value stated. Unless otherwise clear from the context, the numerical values provided herein are modified by the term “about.”

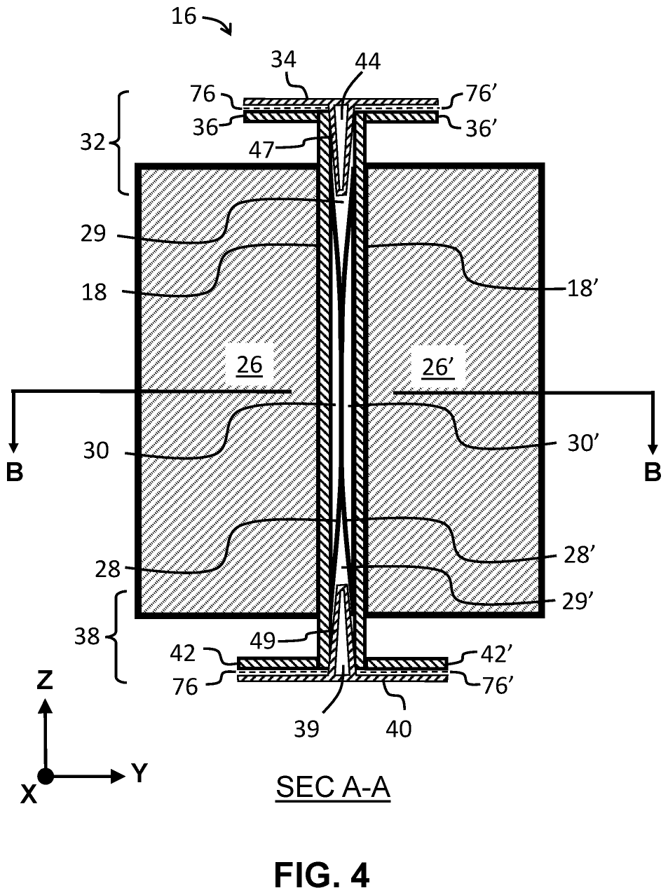

Lastly, directional adjectives and adverbs, such as fore, aft, inboard, outboard, starboard, port, vertical, horizontal, upward, downward, front, back, left, right, etc., may be used with respect to a motor vehicle, such as a forward driving direction of a motor vehicle when the vehicle is operatively oriented on a horizontal driving surface. The directions “left” and “right” are defined by the views as shown as Section A-A of FIGS. 4, 5, 8, 10-13, 15, 20-21, and 28. For example, in FIG. 4 the “left” face plate is item #18 and the “right” face plate is item #18′.

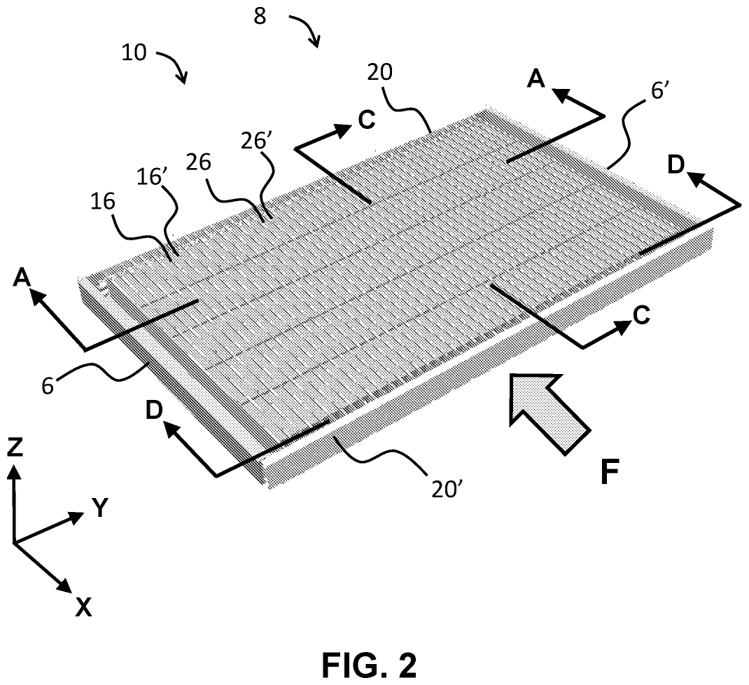

In some examples, the word “transverse”, as it refers to “transverse elastic compliance”, means that the transverse direction is aligned with (i.e., is parallel to) the Y-direction shown in, for example, FIG. 2. The word “transverse” also refers to a direction that is perpendicular to the parallel planes of face plates 18 and 18′. The phrase “structural channel”, “structural cap”, and “structural beam” are used interchangeably. The phrase “Super Beam assembly” refers to an integrated beam structure that comprises a pair of face plates and a pair of attached cover plates that define a pair of corresponding cooling channels that cool each face plate. The phrase “structural channels” includes “structural beams”; and they may have complex cross-sectional shapes, including, but not limited to: I-shaped beams, L-shaped beams, T-shaped beams, M-shaped beams, and Zig-Zag shaped beams.

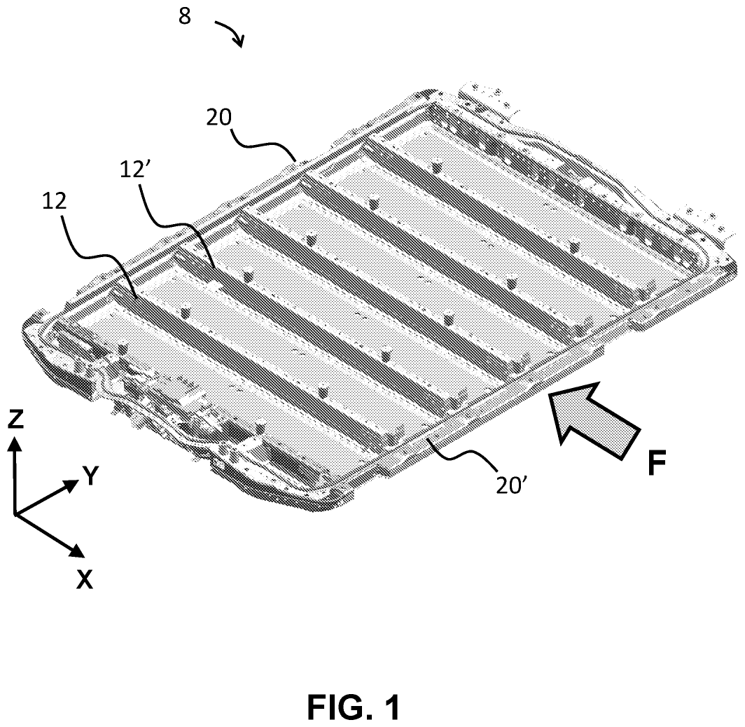

FIG. 1 shows a schematic perspective view of an example of a battery pack frame enclosure 8 for an electric vehicle with five, large, structural cross-beams 12, 12′, etc. that span across the entire width of battery pack frame enclosure 8 along the X-direction. Also shown are two frame enclosure structural side beams 20 and 20′ that run along the length of battery pack frame enclosure 8 in the Y-direction, which protect batteries subjected to a side force, F.

FIG. 2 shows a schematic perspective view of an example of a battery pack frame enclosure 8 holding battery pack 10 for an electric vehicle, with a plurality of Super Beam assemblies 16, 16′, etc. located in-between pairs of adjacent battery cells 26, 26′, and oriented perpendicular to the frame enclosure beams 20 and 20′ that protect against side force, F, according to the present disclosure. Frame enclosure 8 further comprises a pair of structural beams 6 and 6′, which are oriented in the X-direction.

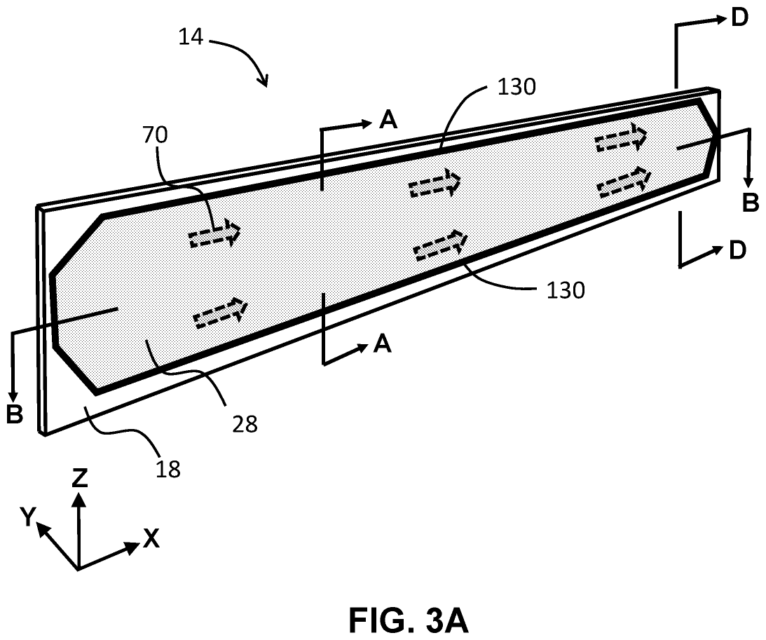

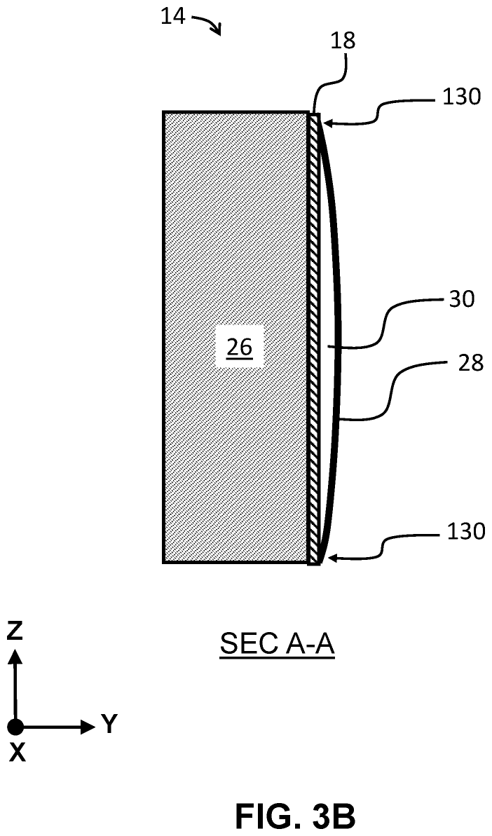

FIG. 3A shows a schematic perspective view of an example of a one-half 14 section of a Super Beam assembly 16 with integrated structural, cooling, and transverse elastic compliance functions, according to the present disclosure. One-half 14 of Super Beam assembly 16 comprises a left face plate 18 that runs longitudinally along the X-direction, with an attached, C-shaped, left coolant channel cover plate 28 with a perimeter 130 that defines an internal coolant channel (see FIG. 4). Coolant inlet 22 and coolant exit 24 cannot be seen in this view. In this example, no perimeter flange(s) are attached to face plate 18.

FIG. 3B shows a schematic cross-section elevation (end) view (Section A-A) of an example of a one-half section 14 of a Super Beam assembly 16 with integrated structural, cooling, and transverse elastic compliance functions, according to the present disclosure. One-half section 14 of Super Beam assembly 16 comprises a vertical face plate 18 with a battery cell disposed adjacent to face plate 18. A C-shaped coolant channel cover plate 28 is attached to face plate 18 around a perimeter 130 of cover plate 28. Coolant channel 30 is defined by face plate 18 on one side of coolant channel 30, and by C-shaped coolant channel cover plate 28 on the other side of coolant channel 30. Coolant channel 30 is hermetically sealed by a perimeter joint 130. Perimeter joint 130 may comprise a welded, brazed, or adhesively-attached connection.

FIG. 4 shows a schematic cross-section elevation (end) view (Section A-A) of an example of a complete Super Beam assembly 16 with integrated structural, cooling, and transverse elastic compliance functions, with top and bottom structural channels 32 and 38, respectively, according to the present disclosure. Super Beam assembly 16 comprises two halves, a first one-half section 14, and a second one-half section 14′ (which is a mirror image of the first one-half section 14). Super Beam assembly 16 comprises a pair of vertical, spaced-apart, parallel left and right face plates 18 and 18′, respectively, that run longitudinally along the X-direction. A pair of left and right battery cells 26 and 26′ are located adjacent to left and right face plates 18 and 18′, respectively. Attached to left and right face plates 18 and 18′ are left and right, attached, C-shaped, coolant channel cover plates 28 and 28′, respectively. Left and right coolant channel cover plates 28 and 28′ define a pair of left and right C-shaped, internal coolant channels 30 and 30′, respectively. A pair of upper and lower air gaps 29 and 29′, respectively, are located in-between left and right face plates 18 and 18′, and are located outside of the left and right internal coolant channels 30 and 30′, respectively. The presence of air gaps 29 and 29′ in-between adjacent left and right face plates 18 and 18′, increases the transverse elastic compliance of Super Beam assembly 16 in the transverse direction (i.e., Y-direction).

Referring still to FIG. 4, top structural channel 32 may comprise a T-shaped upper structural channel 34 with a hollow section 44 of web 47, and a pair of left and right integral upper flanges 36 and 36′. Upper left and right flanges 36 and 36′ are integrally attached to left and right face plates 18 and 18′, respectively. T-shaped upper structural channel 34 may be attached to left and right upper flanges 36 and 36′, for example, a welded or brazed joint. Alternatively, left and right adhesive strips 76 and 76′, respectively may be used to adhesively attach T-shaped upper structural channel 34 to left and right upper flanges 36 and 36′, respectively. T-shaped upper structural channel 34 may be made of, for example, extruded steel or an extruded aluminum alloy. In an example, the hollow section 44 of web 47 may be filled with a solid material, which may be the same or different than the material used to make top structural channel 32.

Referring still to FIG. 4, bottom structural channel 38 comprises a T-shaped lower structural channel 40 with a hollow section 39 of web 49, and a pair of left and right integral lower flanges 42 and 42′, respectively. Left and right lower flanges 42 and 42′ are integrally attached to the bottom of left and right face plates 18 and 18′, respectively. T-shaped lower structural channel 40 may be attached to lower flanges 42 and 42′, for example, a welded or brazed joint. Alternatively, left and right adhesive strips 76 and 76′ may be used to adhesively join T-shaped lower structural channel 40 to left and right lower integral flanges 42 and 42′, respectively. T-shaped lower structural channel 40 may be made of, for example, extruded steel or an extruded aluminum alloy. In an example, the hollow section 39 of web 49 may be filled with a solid material, which may be the same or different than the material used to make bottom structural channel 38.

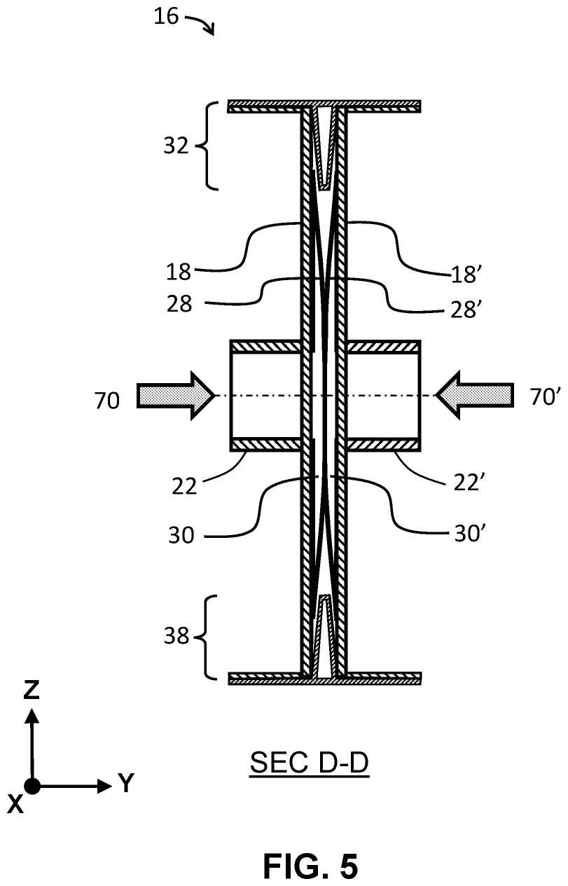

FIG. 5 shows a schematic cross-section elevation (end) view (Section D-D) of an example of a complete Super Beam assembly 16 with integrated structural, cooling, and transverse elastic compliance functions, and top and bottom structural channels 32 and 38, respectfully, according to the present disclosure. Super Beam assembly 16 comprises a pair of left and right, l, spaced-apart, parallel face plates 18 and 18′, that run longitudinally along the X-direction. Left and right battery cells 26 and 26′ are not illustrated in this view. C-shaped, left and right coolant channel cover plates 28 and 28′ are attached to left and right face plates 18 and 18′, respectively. Left and right coolant channel cover plates 28 and 28′ define a pair of left and right C-shaped, internal coolant channels 30 and 30′, respectively. In this cross-sectional view, left and right coolant inlets 22 and 22′, which feeds coolant 70 and 70′ into left and right coolant channels 30 and 30′, respectively.

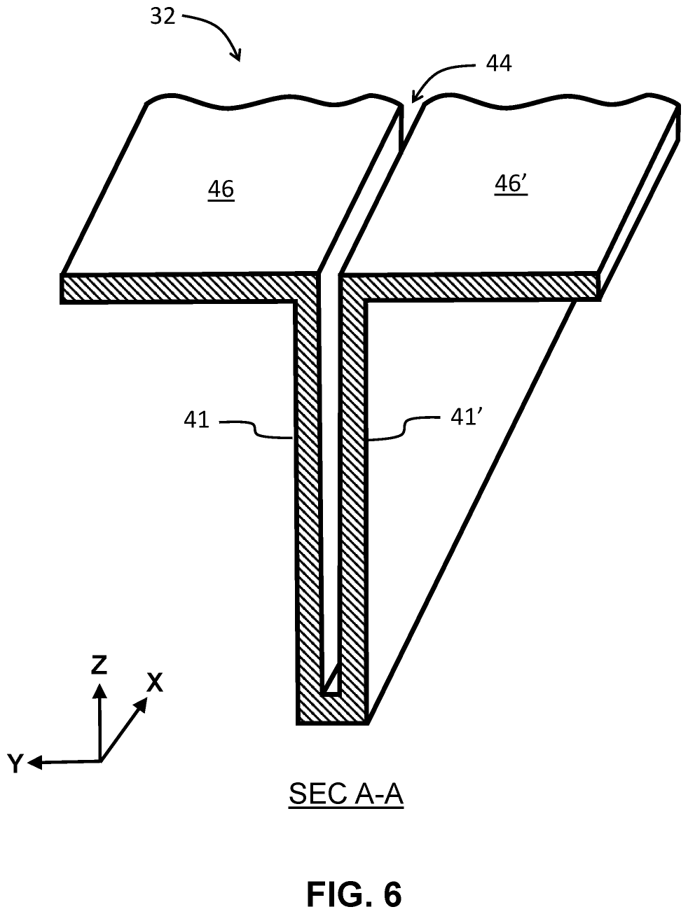

FIG. 6 shows a schematic cross-section elevation view (Section A-A) of an example of a top structural channel 32, according to the present disclosure. Top channel 32 has an monolithic, T-shaped cross-section, which comprises a pair of left and right horizontal flanges 46 and 46′, with an integral pair of vertical web sections 41 and 41′, respectively. A hollow space 44 is disposed in-between the pair of web sections 41 and 41′. T-shaped top structural channel 32 may be made of, for example, extruded steel or an extruded aluminum alloy. In an example, the hollow section 44 may be filled with a solid material, which may be the same or different than the material used to make top structural channel 32.

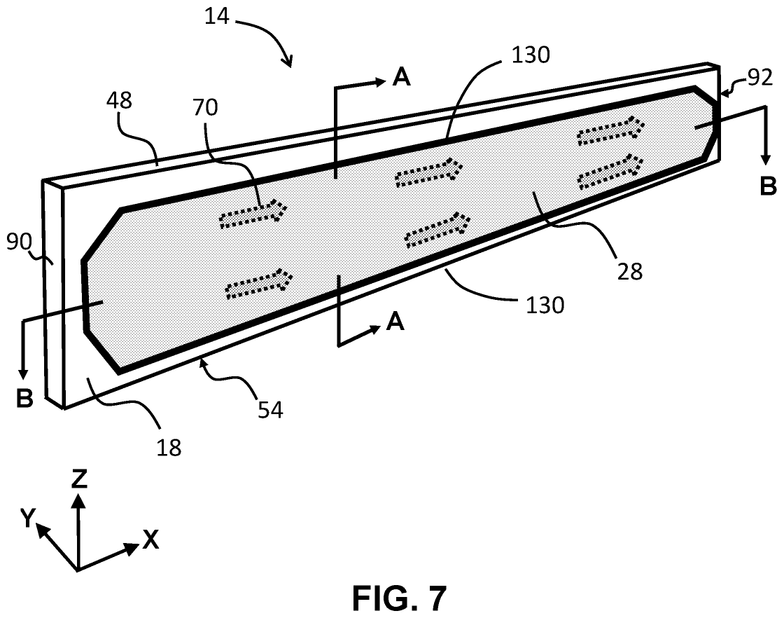

FIG. 7 shows a schematic perspective view of an example of one-half 14 a Super Beam assembly 16 with integrated structural, cooling, and transverse elastic compliance functions, and four examples of integral flange sections 90, 48, 92, and 54, according to the present disclosure. One-half 14 of Super Beam assembly 16 comprises a long, face plate 18 that runs longitudinally along the X-direction. An attached, shaped, coolant channel cover plate 28 with a perimeter 130 defines an internal coolant channel (not seen in this view). See FIG. 4. Proximal and distal coolant inlets 22 and exits 24, respectively, are located at opposite ends of face plate 18, but are not visible in this view. The four integral flange sections 90, 48, 92, and 54 are integrally attached to face plate 18.

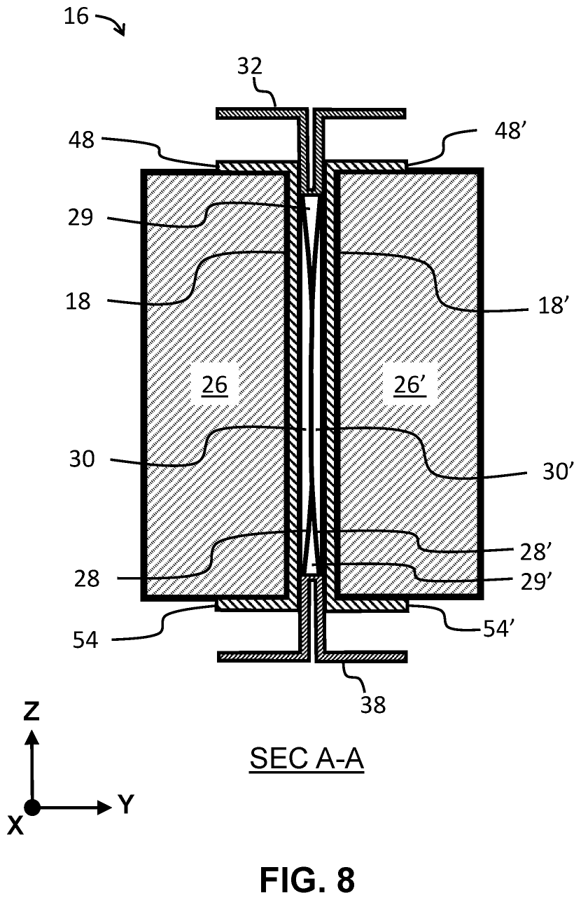

FIG. 8 shows a schematic cross-section elevation (end) view (Section A-A) of an example of a Super Beam assembly 16 with integrated structural, cooling, and transverse elastic compliance functions, and two pairs of left and right longitudinal, integral flange segments (48, 54), and (48′, 54′), respectively, attached to left and right face plates 18 and 18′, respectively, according to the present disclosure. Left and right integral flange segments (48, 54), and (48′, 54′) are configured to hold battery cells 26 and 26′, respectively. The remaining features of FIG. 8 are identical to FIG. 4, and those remaining features won't be repeated here.

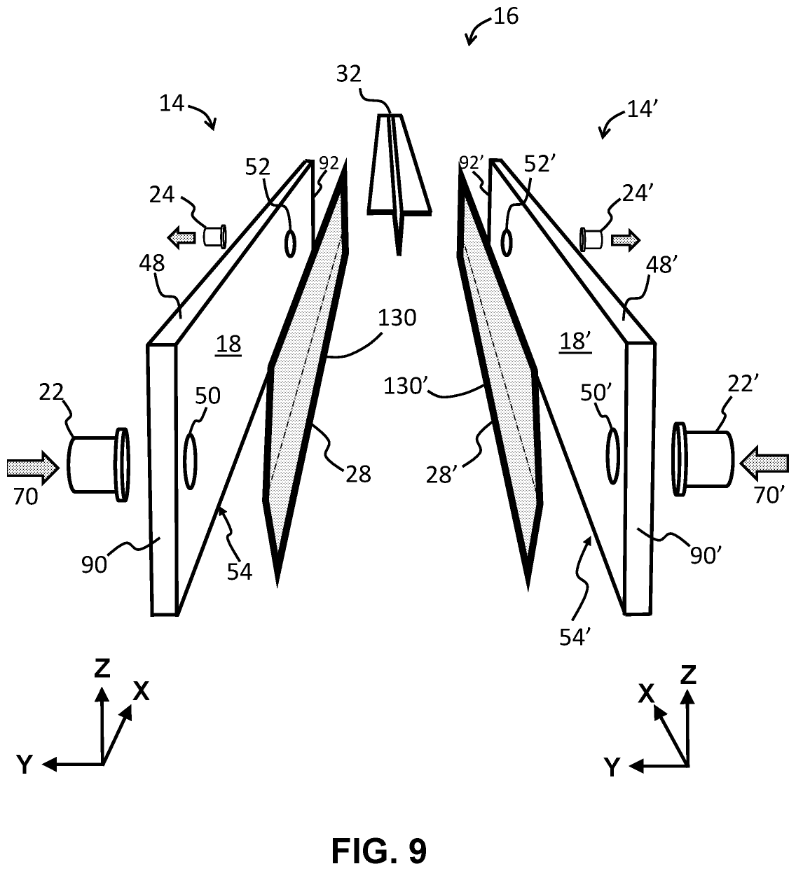

FIG. 9 shows a schematic exploded perspective view of an example of two, one-half beam sections 14 and 14′ of a single Super Beam assembly 16, with integrated structural, cooling, and transverse elastic compliance functions, integral perimeter flanges (48, 54), and (48′, 54′), and a top structural channel 32, according to the present disclosure. The integral perimeter flanges comprise four integral perimeter flange segments 90, 48, 92, and 54 for the left one-half section 14 of Super Beam assembly 16; and flange sections 90′, 48′, 92′, and 54′ for the right one-half section 14′ of Super Beam assembly 16. The left one-half section 14 of Super Beam assembly 16 comprises a face plate 18 that runs longitudinally along the X-direction with an attached, C-shaped coolant channel cover plate 28 with a perimeter 130, 130′ that defines a C-shaped internal coolant channel (See FIG. 4). Proximal and distal coolant inlets 22, 22′ and exits 24, 24′, and their corresponding proximal and distal apertures 50, 52, and 50′, 52′, respectively, in face plates 18 and 18′, are located at opposite ends (i.e., distal and proximal ends) of face plates 18, 18′, which supply flowing coolant 70 to the internal cooling channels 30, 30′ (See FIG. 4) that is defined by coolant channel cover plates 28 and 28′.

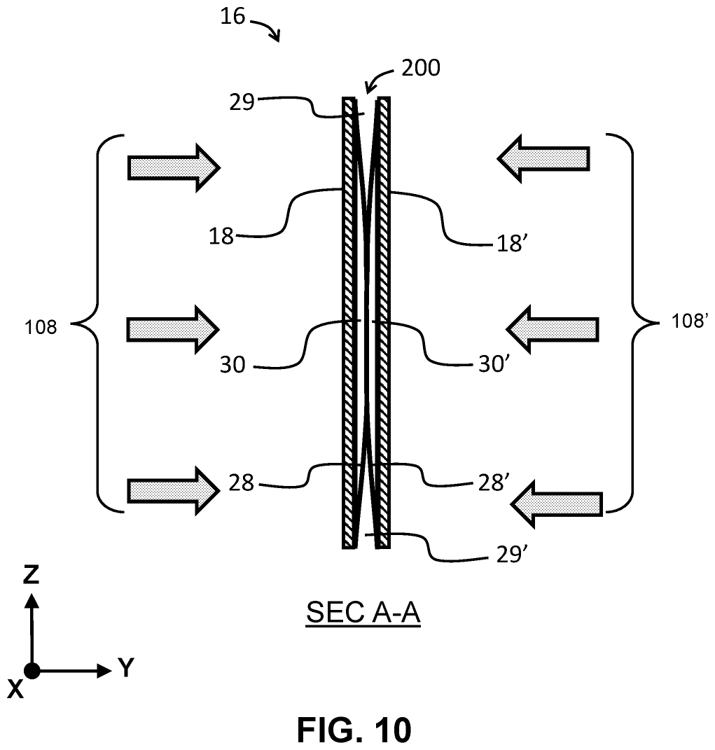

Next, FIGS. 10, 11, 12, and 13 illustrate different cooling channel designs, using the same pair of left and right face plates 18 and 18′.

FIG. 10 shows a schematic cross-section elevation (end) view (Section A-A) of an example of a Super Beam assembly 16 with integrated structural, cooling, and transverse elastic compliance functions, according to the present disclosure. FIG. 10 is identical to FIG. 4, except that the pair of left and right battery cells 26 and 26′ have been removed for clarity, and transverse force arrows 108 and 108′ have been added. Super Beam assembly 16 comprises a pair of parallel face plates 18 and 18′ separated by a gap 200. The width of gap 200 may change (e.g., decrease) as battery cells expand during charging and re-charging cycles. Attached to left and right face plates 18 and 18′ are C-shaped, coolant channel cover plates 28 and 28′, respectively. Left and right coolant channel cover plates 28 and 28′ define a pair of large-sized, C-shaped, opposing left and right internal coolant channels 30 and 30′, respectively. A pair of upper and lower air gaps 29 and 29′ are located in-between left and right face plates 18 and 18′, respectively, and are located outside of the left and right internal coolant channels 30 and 30′, respectively. Optional top and bottom structural channels 32 and 38 have been removed for clarity.

Referring still to FIG. 10, a set of inward-facing, transverse, force arrows, 108 and 108′, are shown, directed along the Y-direction. These transverse compressive forces (i.e., transverse pressure) may be generated from two different sources: (1) pre-compression of a battery pack 10 using pre-loaded bolts (not shown) that run through frame enclosure 8 in the Y-direction, and (2) progressive battery cell transverse expansion in the Y-direction caused by repeated charging/discharging cycles, while being confined by rigid constraints. The relatively thin, left and right C-shaped cover plates 28 and 28′ are inherently elastically compliant in the transverse direction (i.e., because the thin cover plates 28 and 28′ flex elastically like a spring when being loaded by the transverse inward-facing forces 108 and 108′, respectively).

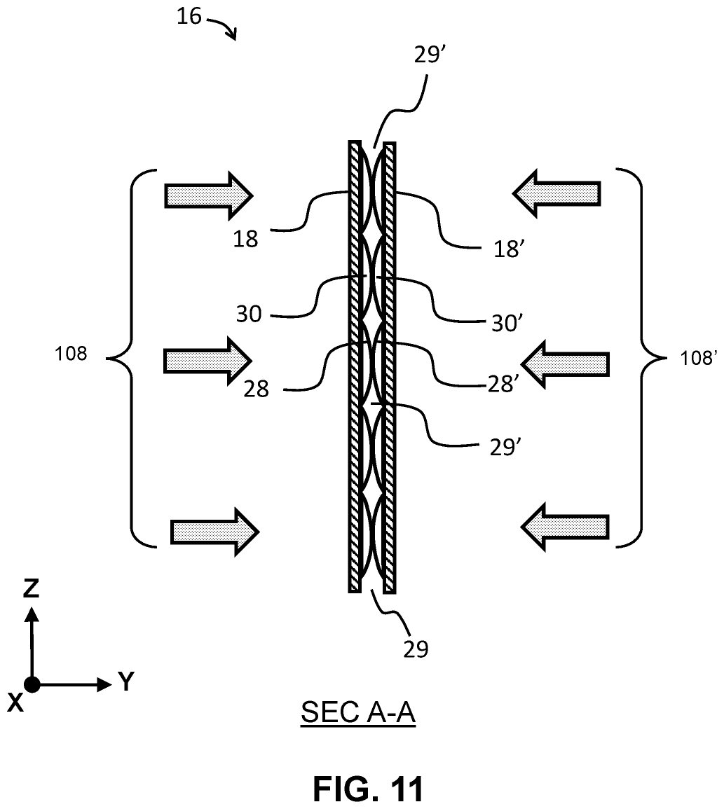

FIG. 11 shows a schematic cross-section elevation (end) view (Section A-A) of an example of a Super Beam assembly 16 with integrated structural, cooling, and transverse elastic compliance functions, according to the present disclosure. Ten medium-sized, opposing left and right coolant channels 30, 30′, etc. are illustrated. The relatively thin left and right cover plates 28 and 28′ are inherently elastically compliant in the transverse (i.e., Y-direction) because they flex elastically like a spring when being loaded by the transverse compressive forces 108 and 108′, respectively. Optional top and bottom structural channels 32 and 38 have been removed for clarity.

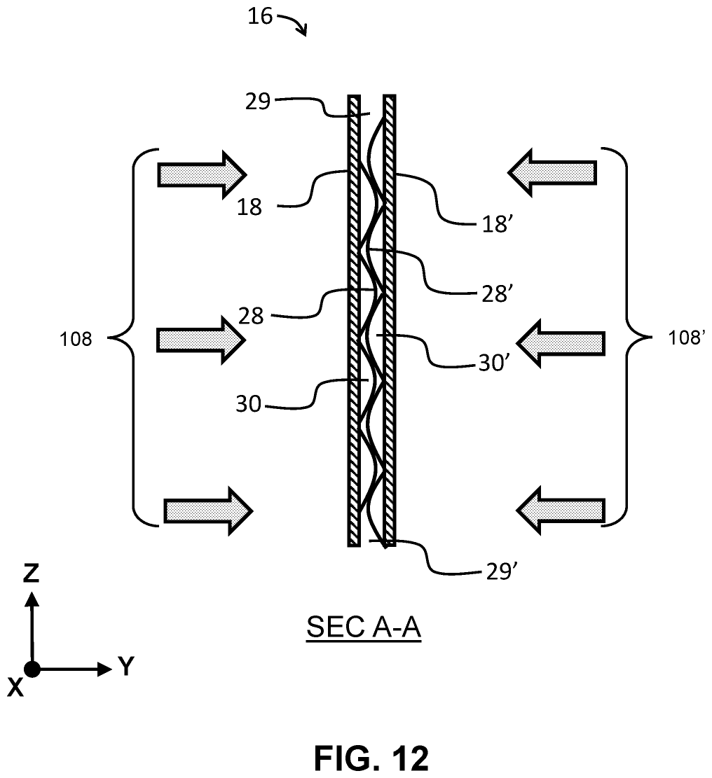

FIG. 12 shows a schematic cross-section elevation (end) view (Section A-A) of an example of a Super Beam assembly 16 with integrated structural, cooling, and transverse elastic compliance functions, according to the present disclosure. Nine, medium-sized, alternating left and right coolant channels 30, 30′, etc. are illustrated. The relatively thin, left and right cover plates 28 and 28′ are inherently elastically compliant in the transverse (i.e., Y-direction) because they flex elastically like a spring when being loaded by the transverse compressive forces 108 and 108′, respectively. A pair of upper and lower air gaps 29 and 29′ are located in-between left and right face plates 18 and 18′, respectively, and are located outside of the left and right internal coolant channels 30 and 30′, respectively. Optional top and bottom structural channels 32 and 38 have been removed for clarity.

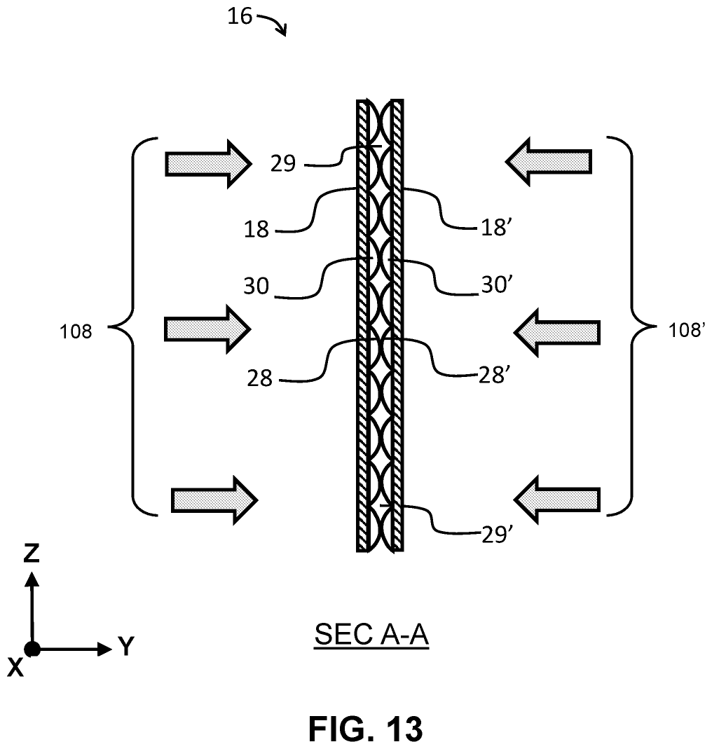

FIG. 13 shows a schematic cross-section elevation (end) view (Section A-A) of an example of a Super Beam assembly 16 with integrated structural, cooling, and transverse elastic compliance functions, according to the present disclosure. Twenty small-sized, opposing left and right coolant channels 30, 30′, etc. are illustrated. The relatively thin, small left and right C-shaped cover plates 28 and 28′ are inherently elastically compliant in the transverse (i.e., Y-direction) because they flex elastically like a spring when being loaded by the transverse compressive forces 108 and 108′, respectively. A pair of upper and lower air gaps 29 and 29′ are located in-between face plates 18 and 18′, respectively, and are located outside of the left and right internal coolant channels 30 and 30′, respectively. Optional top and bottom structural channels 32 and 38 have been removed for clarity.

The examples discussed above regarding FIGS. 10, 11, 12, and 13 illustrate four different coolant channel configurations that allow the transverse elastic compliance to be tuned or adjusted to a specific, desired amount of elastic compliance, depending on the requirements of the battery pack design.

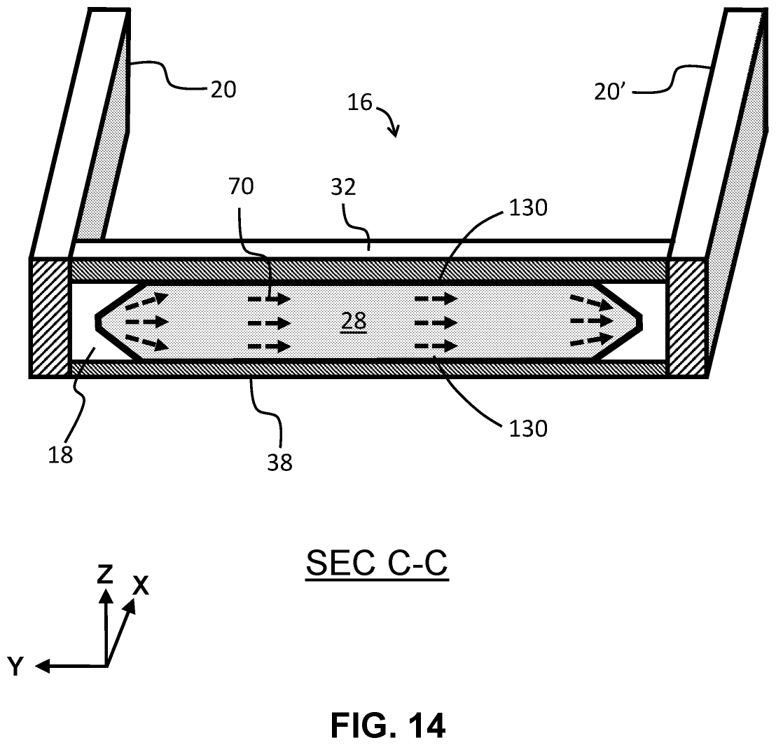

FIG. 14 shows a schematic perspective cross-section (Section C-C) side view of a single example of a Super Beam assembly 16 with integrated structural, cooling, and transverse elastic compliance functions, top and bottom structural channels 32 and 38, respectively, and a pair of left and right horizontal frame enclosure structural beams 20 and 20′ that are aligned along the X-direction, according to the present disclosure. Top and bottom structural channels 32 and 38, along with face plate 18 and coolant channel cover plate 28 span across the entire distance from one frame enclosure beam 20 to the opposite frame enclosure beam 20′. Coolant 70 flows horizontally in the Y-direction. Left and right frame enclosure side beams 20 and 20′ are oriented perpendicular to top and bottom structural channels 32 and 38, respectively, which protect the battery cells (see FIG. 4) and coolant channels (see FIG. 4) when subjected to a side force, F, in the Y-direction.

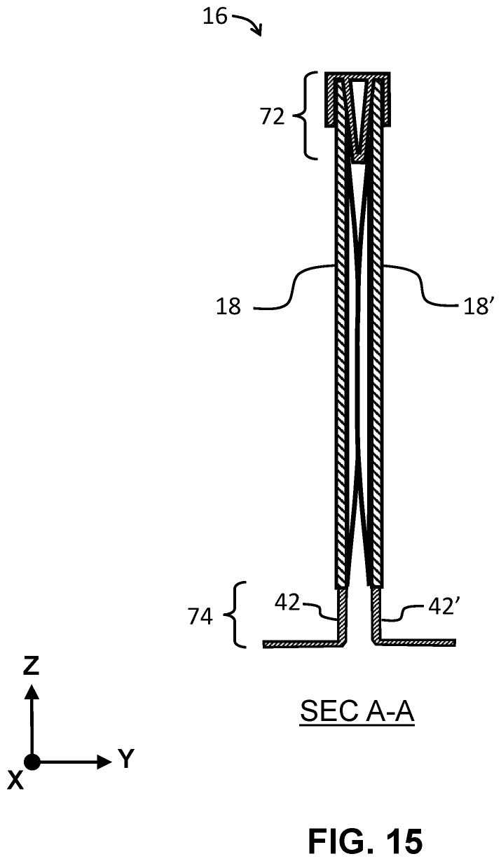

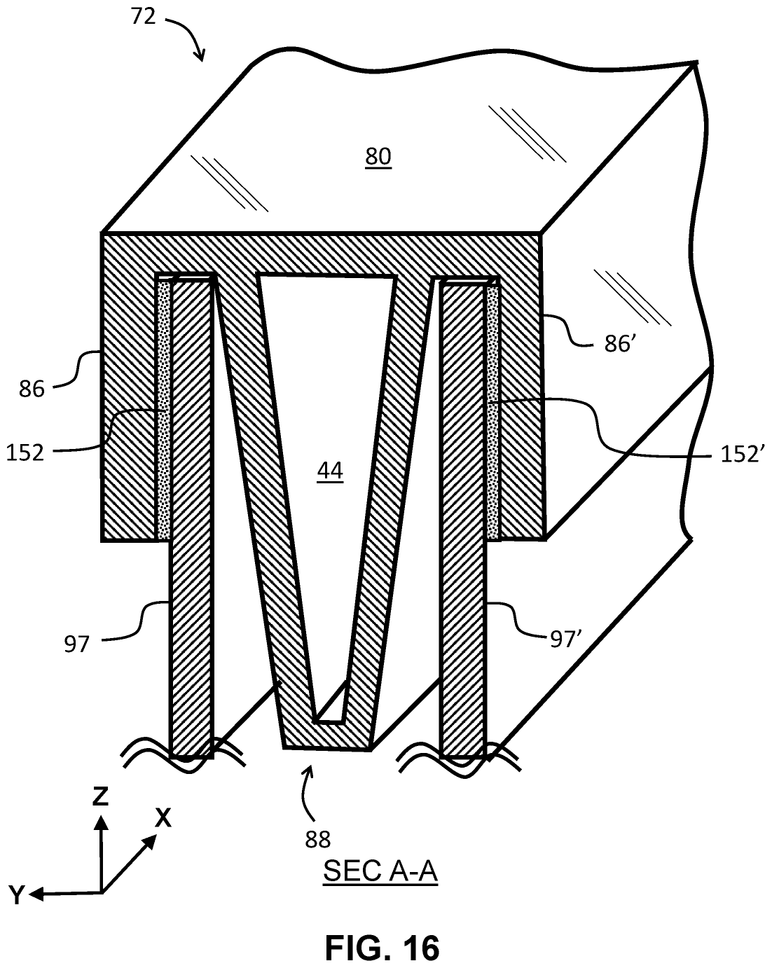

FIG. 15 shows a schematic cross-section elevation (end) view (Section A-A) of an example of a Super Beam assembly 16 with integrated structural, cooling, and transverse elastic compliance functions, and top and bottom structural channels 72 and 74, respectively, according to the present disclosure. The left and right battery cells 26 and 26′ are not shown for clarity. The bottom structural channel 74 comprises a pair of L-shaped channels 42 and 42′. Details of the top structural channel 72 are shown next in the discussion of FIG. 16.

FIG. 16 shows a schematic cross-section orthotropic elevation (end) view (Section A-A) of an example of a top structural channel 72, according to the present disclosure. Top structural channel 72 has a M-shaped cross section and comprises a horizontal top plate 80 with an integral pair of left and right vertical side walls 86 and 86′ that straddle left and right vertical extensions 97 and 97′ of left and right face plates 18 and 18′, respectively. Top structural channel further comprises an integral, V-shaped central web section 88. The central section 44 of the V-shaped central web section 88 may be hollow. In some examples, left and right integral side walls 86 and 86′ may be adhesively attached to left and right upper vertical extensions 97 and 97′ of left and right face plates 18 and 18′ with left and right vertical adhesive strips 152 and 152′, respectively. In an example, the hollow section 72 may be filled with a solid material, which may be the same or different than the material used to make top structural channel 72.

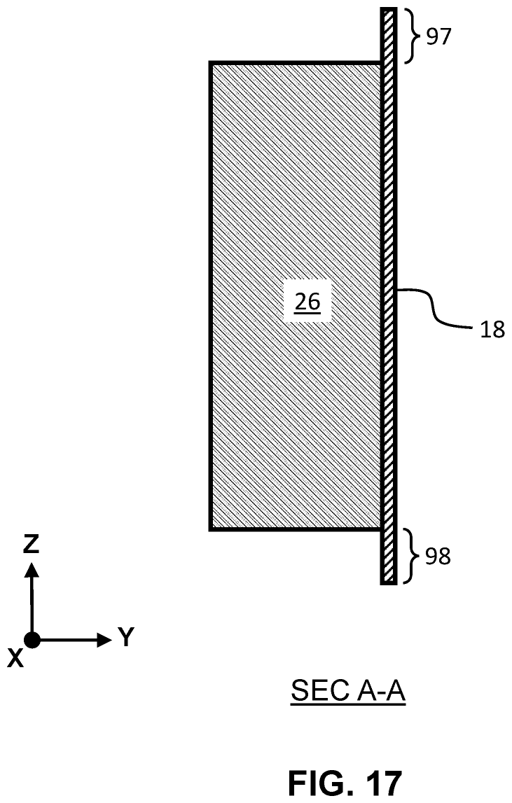

FIG. 17 shows a schematic cross-section elevation (end) view (Section A-A) of an example of a Super Beam assembly face plate 18 with a pair of integral, vertical extensions 97 and 97′, according to the present disclosure. Face plate 18 extends vertically past the top and bottom ends of battery cell 26 with integral, straight, vertical top and bottom extensions 97 and 98, respectively. Coolant channels are not shown for clarity.

FIG. 18 shows a schematic cross-section elevation (end) view (Section A-A) of an example of a Super Beam assembly face plate 18 with integral, L-shaped top and bottom perimeter flanges, 48 and 54, respectively, and a battery cell 26 adjacent to face plate 18, according to the present disclosure. Addition of integral top and bottom perimeter flanges 48 and 54 increase the bending stiffness (and load carrying capacity) of the Super Beam assembly 16. The flange portions 48 and 54 of face plate 18 both face inwards, towards battery cell 26 (i.e., in the negative Y-direction). Coolant channels are not shown for clarity. The width of flanges 48 and 54 may be less than or equal to one-half of the width of battery cell 26 (to allow for a compact assembly of multiple Super Beam assemblies placed side-by-side).

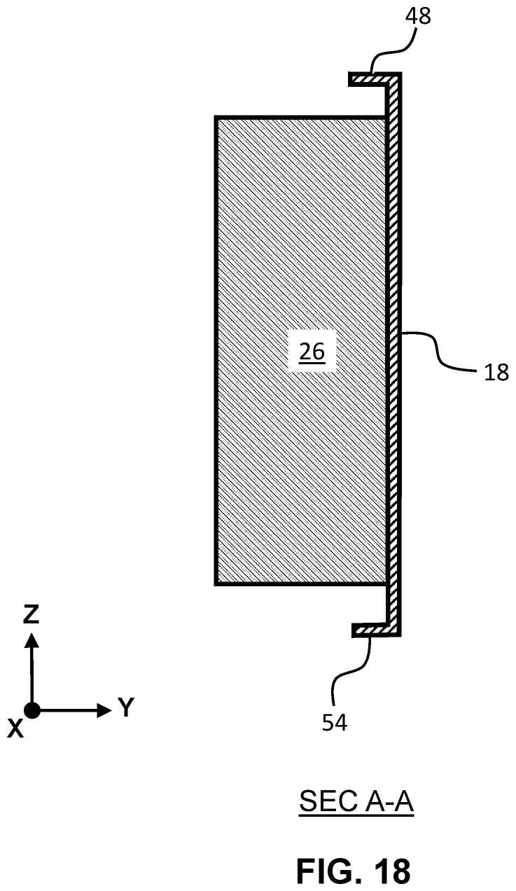

FIG. 19 shows a schematic cross-section elevation (end) view (Section A-A) of an example of a Super Beam assembly face plate 18 with integral, L-shaped top and bottom perimeter flanges 48 and 110, according to the present disclosure. The upper flange 48 faces inwards (i.e., to the left), and lower flange 110 faces outwards (i.e., to the right). Coolant channels are not shown for clarity. The width of flanges 48 and 110 may be less than or equal to one-half of the width of battery cell 26 (to allow for a compact assembly of multiple Super Beam assemblies placed side-by-side).

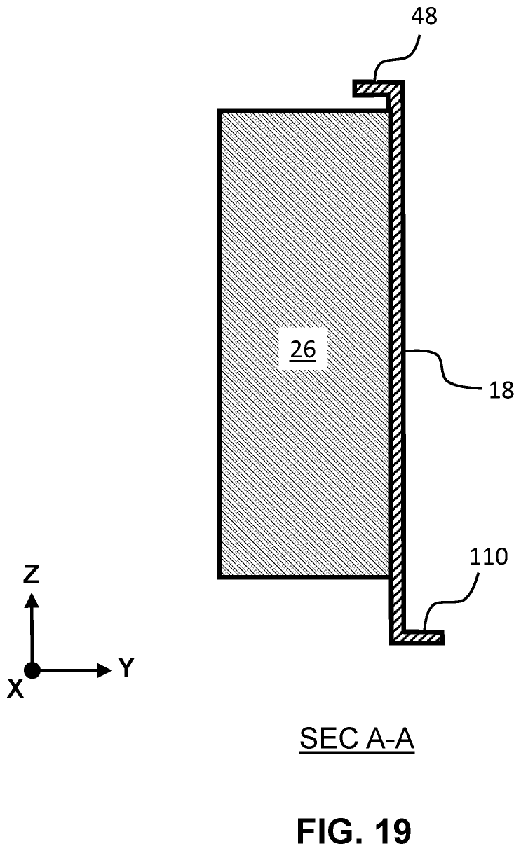

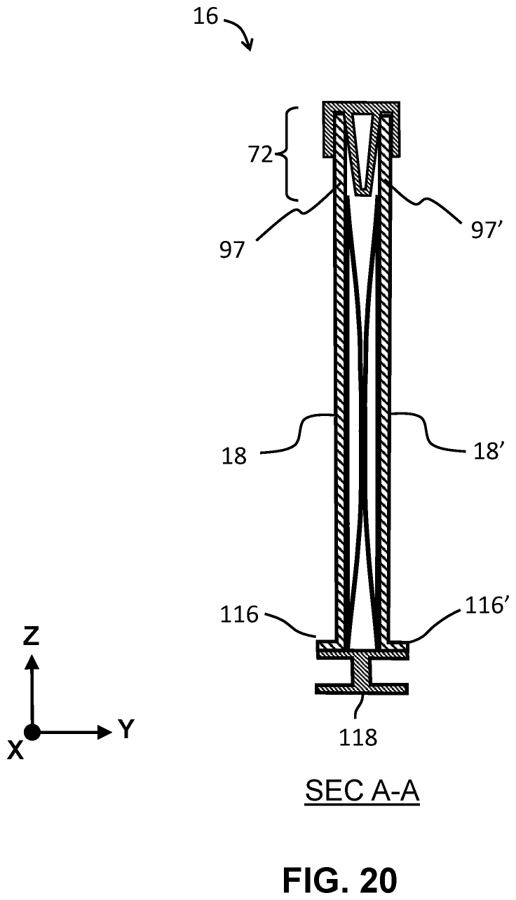

FIG. 20 shows a schematic cross-section elevation (end) view (Section A-A) of an example of a Super Beam assembly 16 with integrated structural, cooling, and transverse elastic compliance functions, and top and bottom structural channels 72 and 118, respectively, according to the present disclosure. Top structural channel 72 is shown in more detail in FIG. 16. The left and right upper extensions 97 and 97′ of left and right face plates 18 and 18′, respectively, insert into top structural channel 72, as shown in FIG. 16. The lower ends of left and right face plates 18 and 18′ comprise outwardly-facing left and right flange sections 116 and 116′, respectively. The pair of adjoining battery cells are not shown for clarity. Bottom structural channel 118 may have an I-shaped cross-section.

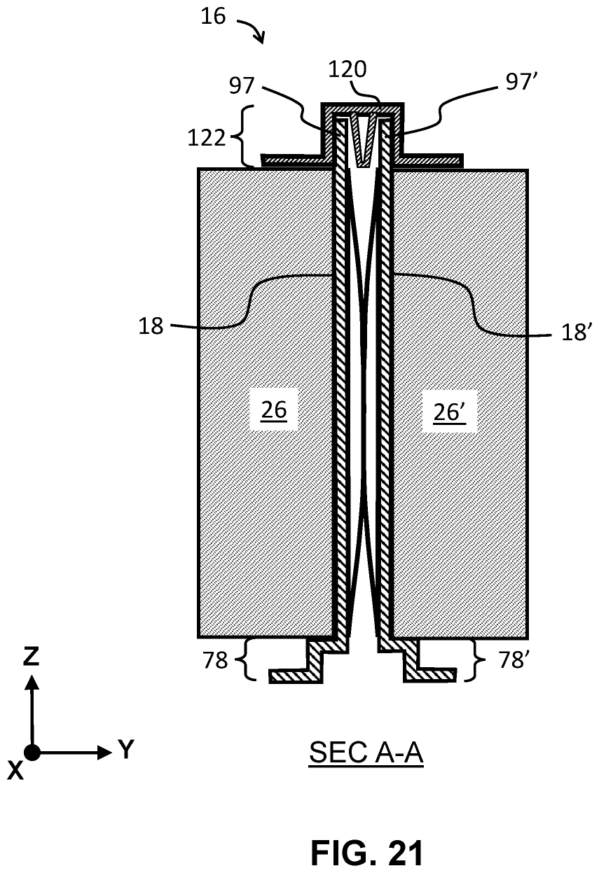

FIG. 21 shows a schematic cross-section elevation (end) view (Section A-A) of an example of a Super Beam assembly 16 with integrated structural, cooling, and transverse elastic compliance functions, and top structural channel 122 and bottom structural channel 78 and 78′, according to the present disclosure. The top structural channel 122 may comprise an inverted-U cross-sectional shape 120 that straddles the left and right upper extensions 97 and 97′ of left and right face plates 18 and 18′ respectively. Inverted-U structural channel 120 may be adhesively attached to left and right upper extensions 97 and 97′ of left and right face plates 18 and 18′, respectively. The bottom left and right ends 78 and 78′ of left and right face plates 18 and 18′, respectively, comprise left and right integral flanges 78 and 78′ that have a “dogleg” or Zig-Zag cross-sectional shape.

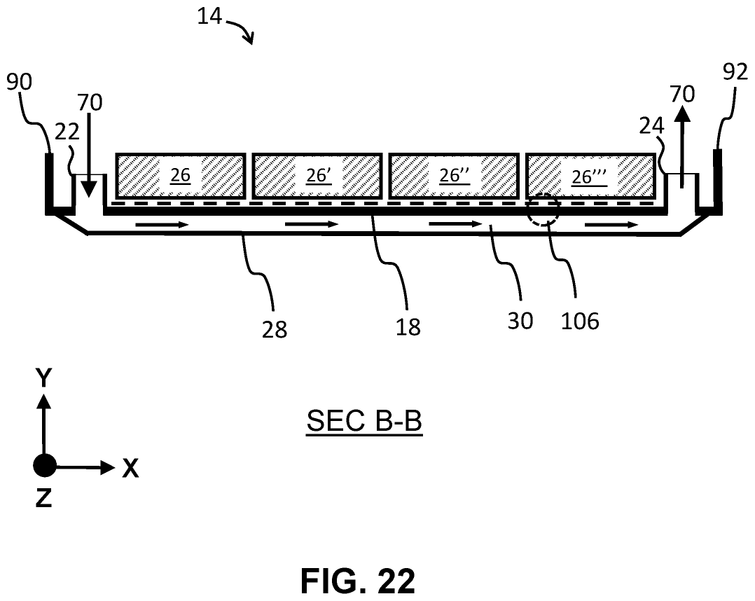

FIG. 22 shows a schematic cross-section plan view (Section B-B) of an example of a Super Beam assembly 16 with integrated structural, cooling, and transverse elastic compliance functions, and integral perimeter flanges 90 and 92, according to the present disclosure. Battery cells 26, 26′, 26″, and 26′″ are located in-between integral perimeter flanges 90 and 92 and sit adjacent to face plate 18. An optional compliant, thermal interface material (TIM) layer 106 may be disposed in-between battery cell 26 and face plate 18. TIM layer 106 may be adhesive and may be used to adhere battery cell 26 to face plate 18. Coolant channel 30 is defined by face plate 18 on one side and cover plate 28 on the other side. Coolant 70 flows into inlet port 22, then flows horizontal in the X-direction through coolant channel 30, and finally exits out through outlet port 24.

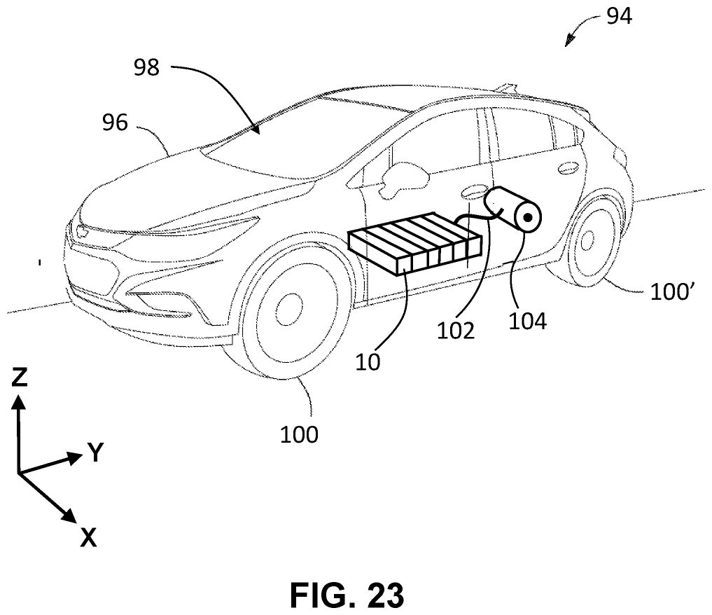

FIG. 23 shows a schematic perspective view of an example of an electric motor vehicle 94 with a rechargeable battery pack 10, according to the present disclosure. Electric motor vehicle 94 includes a vehicle body 96, passenger compartment 98, a plurality of road wheels 100, 100′, etc. attached to vehicle body 96, and a rechargeable battery pack 10 located inside of electric motor vehicle 94. Electric motor vehicle 94 further comprises an electric traction motor 104 attached to vehicle body 96 that is operable to drive one or more of the road wheels 100, 100′, etc. that propels electric motor vehicle 94. The rechargeable battery pack 10 is attached to vehicle body 96 and is electrically connected to traction motor 104 with electric power cable 102.

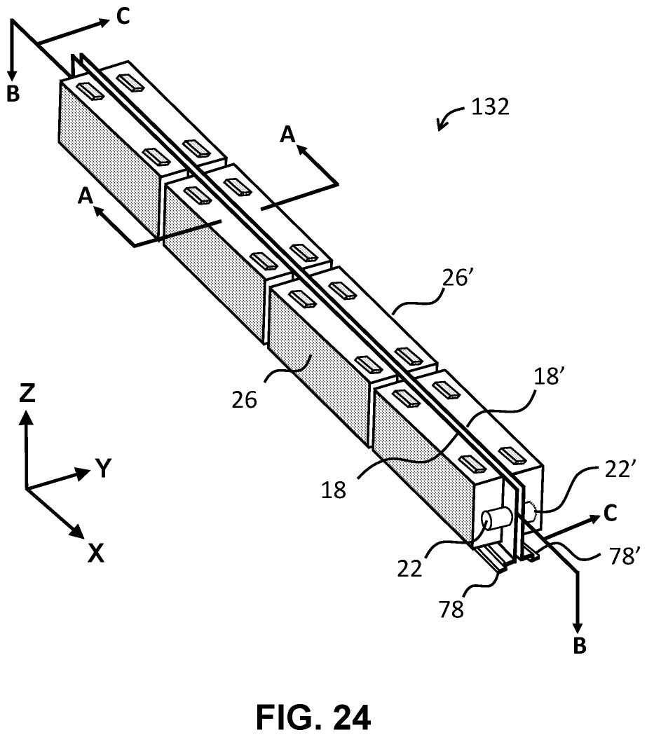

FIG. 24 shows a schematic perspective view of an example of a Super Beam assembly 132 with a full complement of left and right battery cells 26, 26′, etc, according to the present disclosure. Assembly 132 comprises a pair of left and right face plates 18 and 18′, with left and right coolant inlets 22 and 22′, and four pairs of left and right battery cells (26, 26′), etc. that are located on both sides of left and right face plates 18 and 18′, respectively, and are disposed along the length of assembly 132 in the X-direction. The internal cooling channels can't be seen in this illustration. Bottom left and right structural channels 78 and 78′ are illustrated.

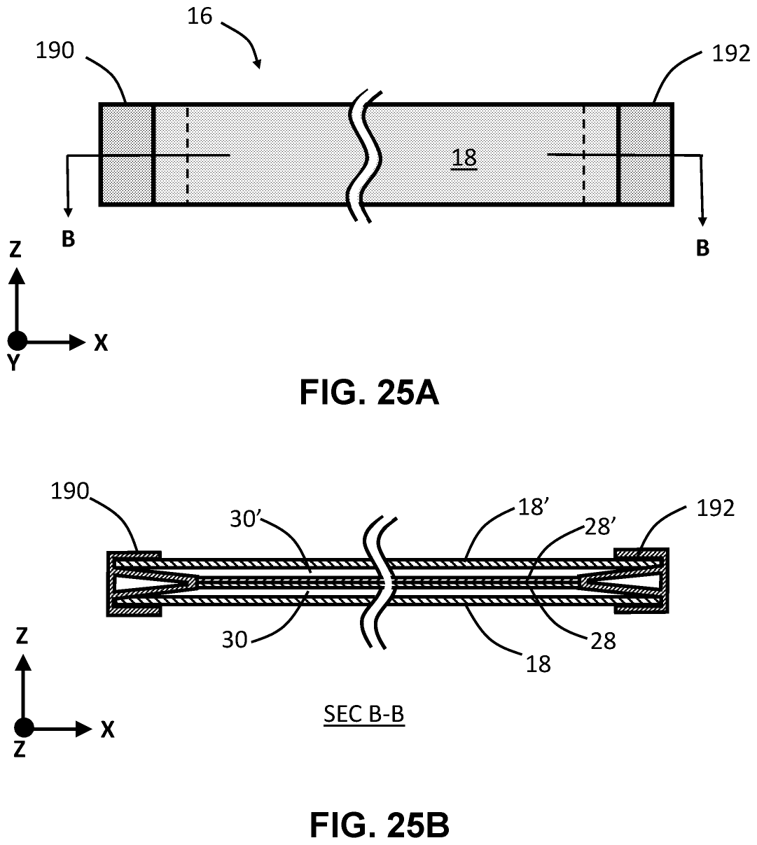

FIG. 25A shows a schematic side elevation view of an example of a pair of vertical end structural channels 190 and 192 attached to proximal and distal ends 194 and 196, respectively, of a Super Beam assembly 16, according to the present disclosure. Super Beam assembly 16 comprises a right face plate 18 in this example.

FIG. 25B shows a schematic plan (top) cross-section view (Section B-B) of an example of a pair of vertical end structural channels 190 and 192 attached to proximal and distal ends 194 and 196, respectively, of a Super Beam assembly 16, according to the present disclosure. Super Beam assembly 16 comprises a right face plate 18 and a left face plate 18′; and further comprises a left coolant channel cover plate 28′ and a right coolant channel cover plate 28. Super Beam assembly 16 further comprises a left coolant channel 30′ and a right coolant channel 30. End structural channels 190 and 192 may hermetically seal the proximal and distal ends 194 and 196, respectively, of left and right coolant channels 30 and 30′.

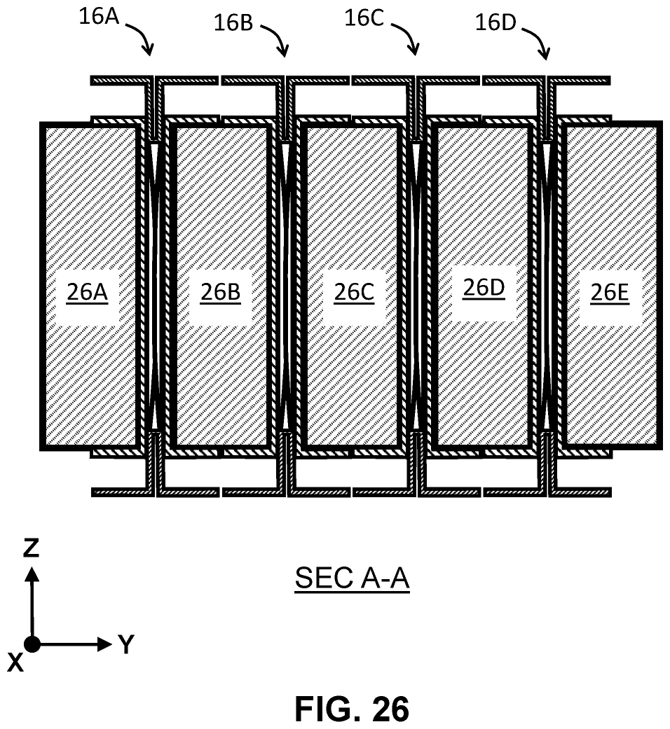

FIG. 26 shows a schematic cross-section view (Section A-A) of an example of four adjacent Super Beam assemblies supporting five battery cells 26A, 26B, 26C, 26D, and 26E, according to the present disclosure. Super Beam assemblies 16A, 16B, 16C, and 16D are oriented parallel to each other, with battery cells 26A, 26B, 26C, 26D, and 26E disposed adjacent to, and located in-between, adjacent pairs of Super Beam assemblies (16A, 16B), (16B, 16C), (16C, 16D), respectively. The total width of each Super Beam assembly 16A, 16B, 16C, or 16D may be less than or equal to the width of a battery cell 26A, 26B, 26C, 26D, or 26E, to allow for making a compact assembly of multiple Super Beam assemblies and battery cells side-by-side in the transverse direction (Y-axis).

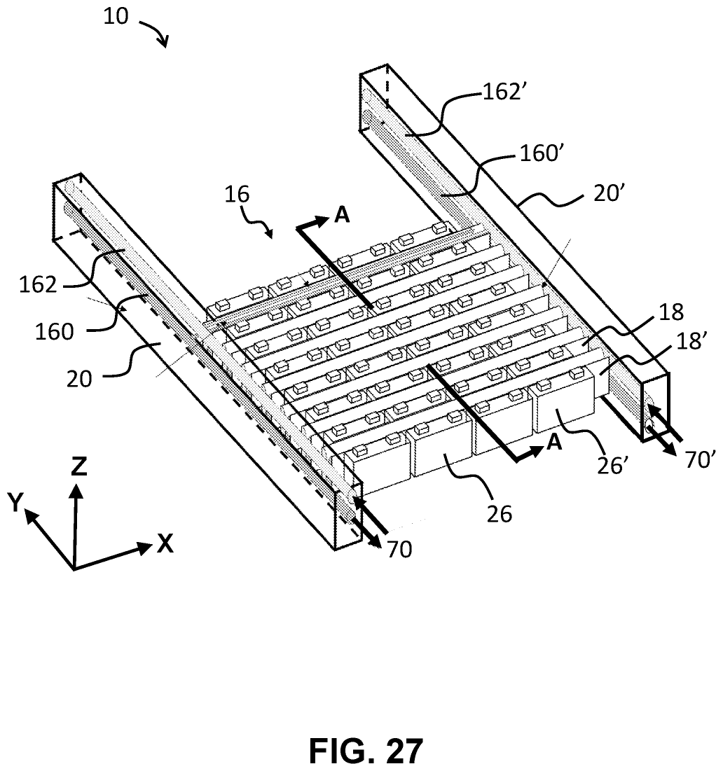

FIG. 27 shows a schematic perspective of an example of seven, assembled Super Beam assemblies 16 holding eight rows of left and right battery cells 26, 26′, etc., arranged in parallel rows in a battery pack assembly 10, according to the present disclosure. Super Beam assembly 16 is one example of the seven parallel Super Beam assemblies 16, 16′, etc. that hold a total of thirty-two battery cells 26, 26′, etc. A pair of left and right frame enclosure beams 20 and 20′ are oriented longitudinally along the Y-direction and are attached to the proximal and distal ends of perpendicular face plates 18, 18′, etc. Left and right coolant channels 30 and 30′, that are located in-between adjacent face plates 18 and 18′, are not shown in this illustration. Left and right coolant inlet/outlet supply pipes 160, 162, and 160′, 162′, are disposed inside of frame enclosure beams 20 and 20′, respectively, and run parallel to the Y-direction. Left and right inlet/outlet feed pipes 160, 162, and 160′ and 162′ supply coolant 70 to left and right coolant channels 30 and 30′ that are located in-between adjacent face plates 18 and 18′ (See, e.g., FIG. 4).

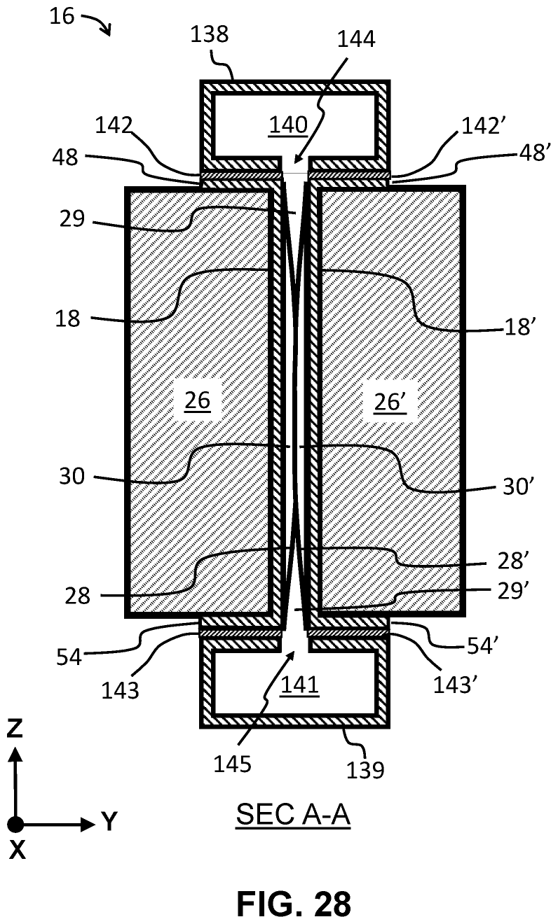

FIG. 28 shows a schematic cross-section view (Section A-A) of an example of a Super Beam assembly 16 holding left and right battery cells 26 and 26′ with top and bottom Thermal Management Propagation (TMP) suppression channels 138 and 139, respectively, according to the present disclosure. Top TMP suppression channel 138 may have a rectangular (or circular) cross-section, with a lower opening 144 disposed on a bottom side of top channel 138 that fluidically connects with air gap 29 that is disposed in-between left and right face plates 18 and 18′. In some examples, top internal volume 140 (disposed inside of TMP suppression channel 138) may be filled with air. Thermal modelling of the transient temperature rise in a battery cell adjacent to a battery cell undergoing a TMP event, predicts that the peak batter cell temperature after 100 seconds may be reduced by approximately 32 C by using top TMP suppression channel 138. In another example, top internal volume 140 may be filled with a thermal phase-change material (not shown) that absorbs heat and reduces temperature rise in adjacent battery cells during a TMP event.

Referring still to FIG. 28, this illustration also shows an example of a bottom TMP suppression channel 139, with bottom internal volume 141 and upper opening 145 disposed on an upper side of bottom channel 139. Both top and bottom TMP suppression channels 138 and 139, respectively, may be attached to face plate flanges 48, 48′ and 54, 54′, respectively, using left and right upper adhesive strips 142 and 142′, respectively, and left and right lower adhesive strips 143 and 143′, respectively. The left and right adhesive strips 142, 142′, 143, and 143′ may be made of an adhesive material that melts at a relatively low temperature (e.g., 100 C), which may serve as a “thermal fuse” that melts, detaches, and thermally-decouples a hot battery cell (e.g., cell 26) experiencing a thermal management event from an adjacent, cold battery cell (e.g., cell 26′), so as to prevent thermal management propagation. Also, the vertical height and horizontal width of the upper and bottom TMP suppression channels 138 and 139, respectively may be increased (independently, or in combination) to increase the thermal resistance path between adjacent left and right battery cells 26 and 26′ by providing a longer conduction path between adjacent left and right battery cells 26 and 26′.

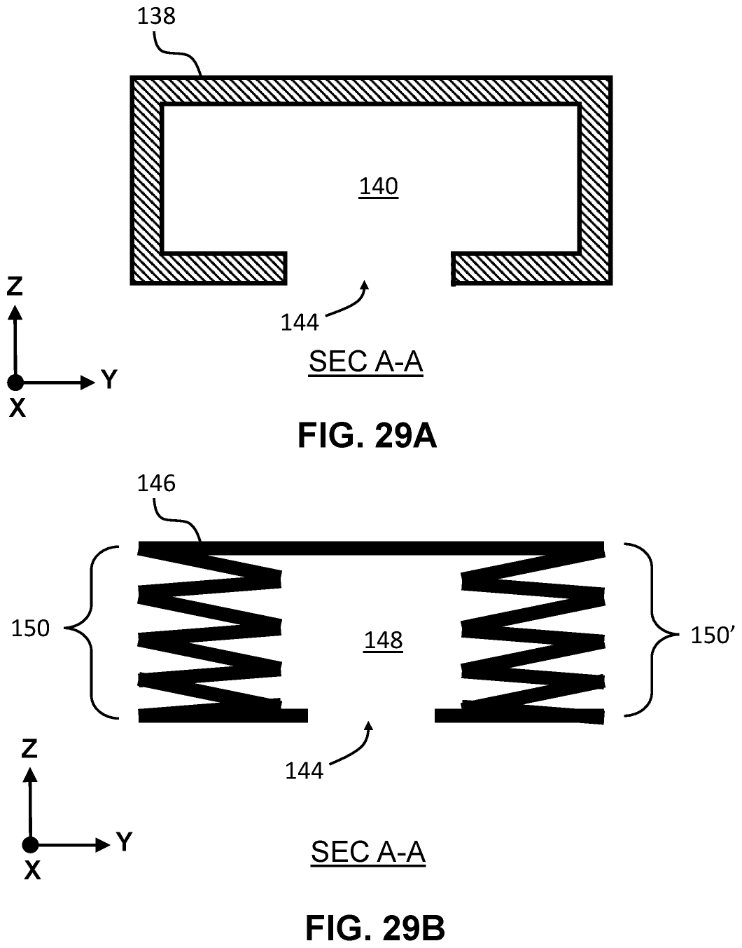

FIG. 29A shows a schematic cross-section view (Section A-A) of an example of a top TMP suppression channel 138, according to the present disclosure. Suppression channel 138 has a rectangular cross-section; an internal volume 140 (which may be filled with air, or a phase-change material, in some examples); and a lower opening 144.

FIG. 29B shows a schematic cross-section view (Section A-A) of an example of an alternate design for a TMP suppression channel 146 (top or bottom channel) with four “Z-fold”, left and right bellows segments 150 and 150′, according to the present disclosure. The four, Z-fold, left and right bellows segments 150 and 150′ are used to increase the total thermal path-length between adjacent battery cells, which increases thermal resistance from one side of TMP suppression channel 146 to the opposite side of channel 146. Suppression channel 146 has a bellows-shaped cross-section, an internal volume 148 (which may be filled with air or a phase-change material, in some examples), and a lower opening 144.

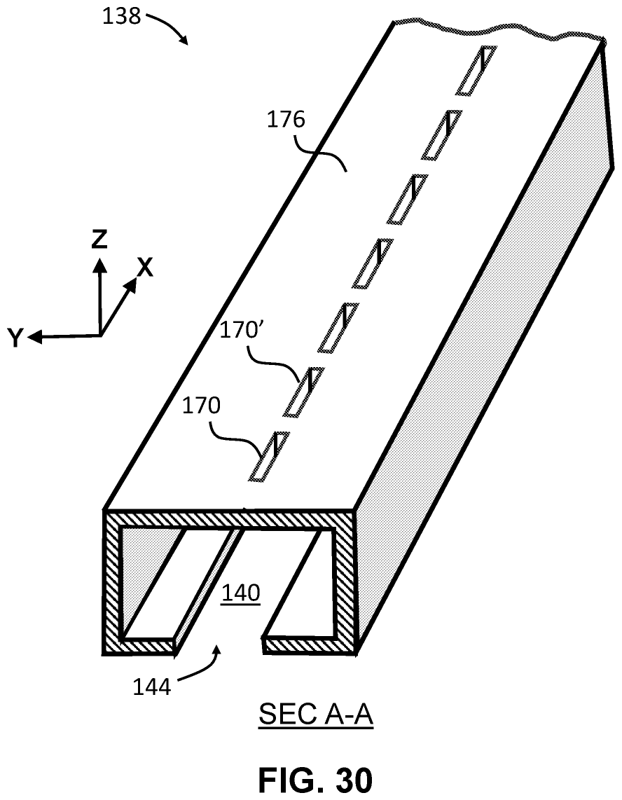

FIG. 30 shows a schematic perspective cross-section view (Section A-A) of an example of a top TMP suppression channel 138 with a series of longitudinal slots 170, 170′, etc., according to the present disclosure. TMP suppression channel 138 has a horizontal, longitudinal upper plate 176; a lower opening 144 disposed on a bottom side of top channel 138; and a central volume 140 that may be hollow or filled with a phase-change substance (wax, solder, etc.) that has a high heat absorption capacity. A series of longitudinal slots 170, 170′, etc. is disposed lengthwise along the X-direction, which may be in a middle location in the Y-direction. The purpose of the series of longitudinal slots 170, 170′ is to decrease the overall transverse (i.e., in the Y-direction) effective thermal conductivity by inserting a series of openings that reduce or block transverse heat conduction. This serves to reduce the transient temperature rise in a battery cell 26 (See FIG. 4) that sits adjacent to a battery cell 26′ that is undergoing a TMP event. In one example, a plurality of multiple series of longitudinal slots 170, 170′, etc. may be disposed in the longitudinal upper plate 176 of TMP suppression channel 138. In another example, the longitudinal slots 172, 172′, etc. may only partially penetrate into the wall thickness of longitudinal upper plate 176, in order to preserve a hermetic seal of the TMP suppression channel 138.

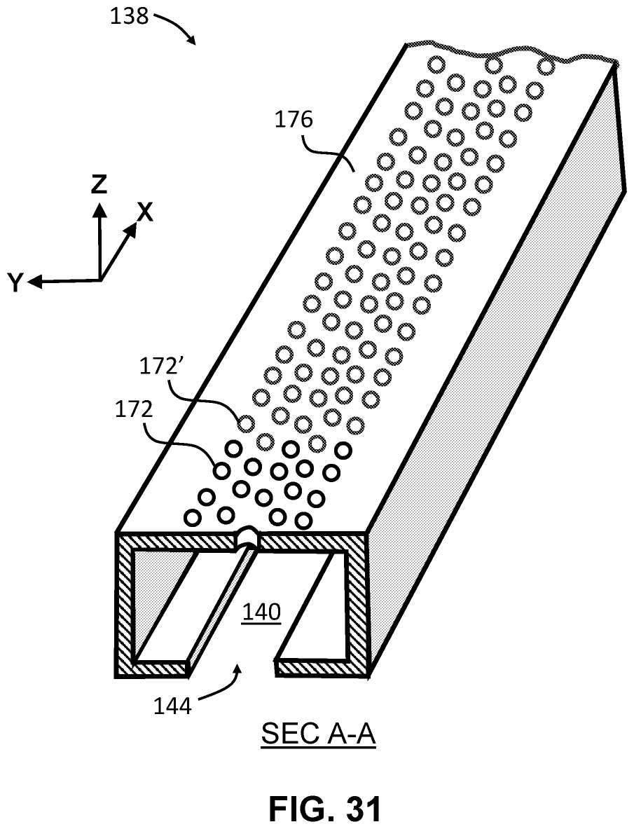

FIG. 31 shows a schematic perspective cross-section view (Section A-A) of an example of a top TMP suppression channel 138 with a series of multiple perforations 172, 172′, according to the present disclosure. TMP suppression channel 138 has a horizontal, longitudinal upper plate 176; a lower opening 144 disposed on a bottom side of top channel 138; and a central volume 140 that may be hollow or filled with a phase-change substance (wax, solder, etc.) that has a high heat absorption capacity. A series of multiple perforations 172, 172′, etc. are disposed along the X-direction. The purpose of this series of multiple perforations 172, 172′ is to decrease the transverse (i.e., in the Y-direction) effective thermal conductivity by inserting a series of openings that reduce or block the transverse heat conduction, which serves to reduce the transient temperature rise in a battery cell 26 (See FIG. 4) that is disposed adjacent to a battery cell 26′ that is undergoing a TMP event. In an example, the perforations may only partially penetrate through the wall thickness of longitudinal upper plate 176, which preserves a hermetic seal of the TMP suppression channel 138.

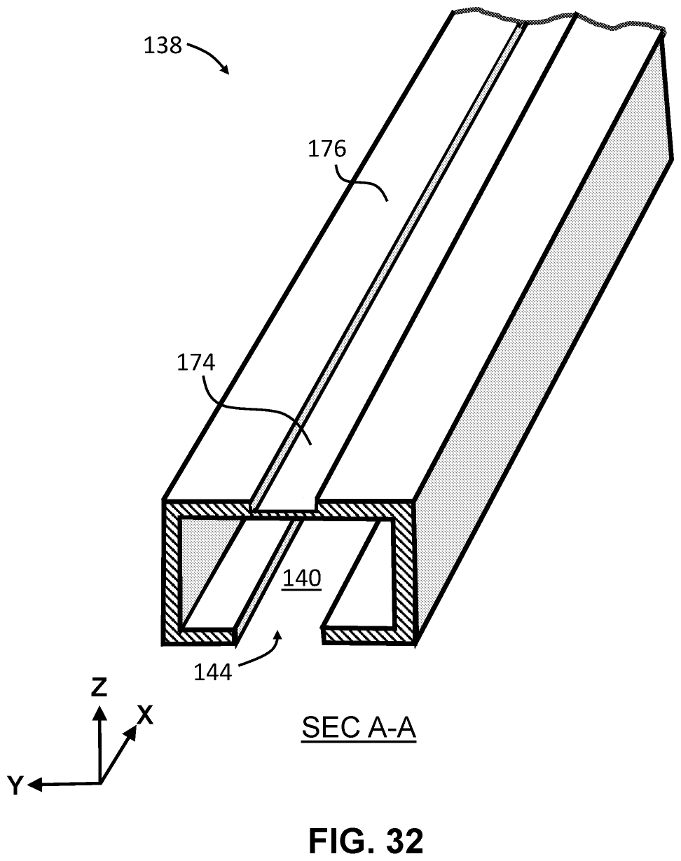

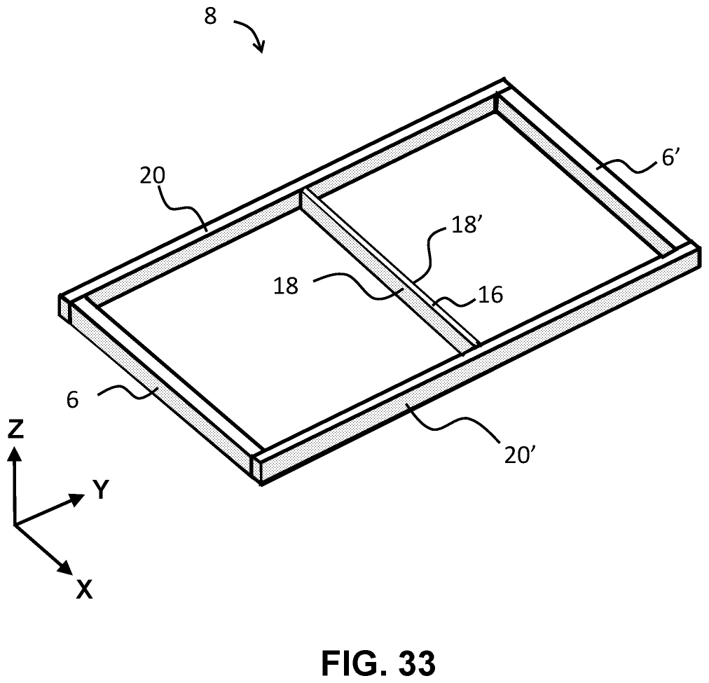

FIG. 32 shows a schematic perspective cross-section view (Section A-A) of an example of a top TMP suppression channel 138 with a central, longitudinal, recessed groove (or partial slot) 174, according to the present disclosure. TMP suppression channel 138 has a horizontal, longitudinal upper plate 176; a lower opening 144 disposed on a bottom side of top channel 138; and a central volume 140 that may be hollow or filled with a phase-change substance (wax, solder, etc.) that has a high heat absorption capacity. One or more longitudinal recessed grooves 174 (only one groove 174 is illustrated) may be disposed along the longitudinal X-direction, in a middle location in the Y-direction. The purpose of the one or more recessed grooves 174 is to decrease the transverse effective thermal conductivity (i.e., in the Y-direction) by locally reducing the wall thickness of longitudinal upper plate 176 to reduce transverse heat conduction in the Y-direction. This configuration serves to reduce the transient temperature rise in a regular battery cell 26 (See FIG. 4) that is disposed adjacent to a battery cell 26′ that is undergoing a TMP event.

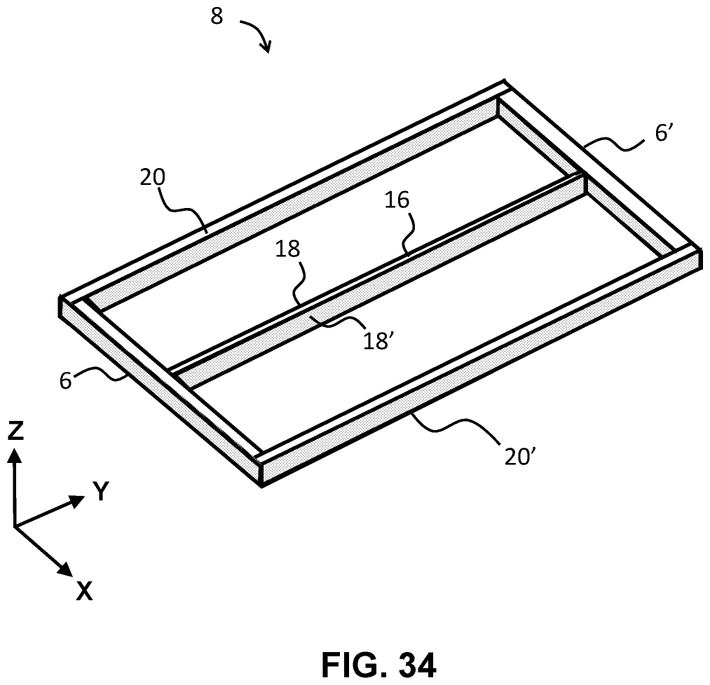

FIG. 33 shows a schematic perspective view of a battery pack frame enclosure 8 with a single Super Beam assembly 16 oriented longitudinally (side-to-side) along the X-direction, according to the present disclosure. Frame enclosure 8 comprises parallel side beams 20 and 20′ and parallel front and back beams, 6 and 6′, respectively. Parallel face plates 18 and 18′ are oriented longitudinally (side-to-side) along the X-direction. For a Super Beam assembly 16 that is oriented longitudinally (side-to-side) along the X-direction, face plates 18 and 18′ (and any top and/or bottom structural channels (not shown)), provide structural support to the internal cooling channels (not shown) and battery cells (not shown) when a side beam 20 or 20′ is subjected to a side force (see FIGS. 1 and 2).

FIG. 34 shows a schematic perspective view of a battery pack frame enclosure 8 with a single Super Beam assembly 16 oriented longitudinally (front-to-back) along the Y-direction, according to the present disclosure. Parallel face plates 18 and 18′ are also oriented longitudinally (front-to-back) along the Y-direction.

In some examples, coolant flow 70 in left and right cooling channels 30 and 30′ (see, e.g., FIG. 4) may be in the same direction (e.g., parallel to the X-axis). In other examples, coolant 70 may flow in opposite (i.e., counter-flow) directions (e.g., parallel to the X-axis). For example, coolant flowing in the left channel 30 may flow in the positive X-direction, while coolant flowing in the right channel 30′ may counter-flow in the negative X-direction. Alternatively, coolant flowing in the left channel 30 may flow in the negative X-direction, while coolant flowing in the right channel 30′ may be counter-flow in the positive X-direction. The use of a counterflow cooling circuit may result in more uniform battery temperatures across a set of battery cells 26, 26′, etc.

In some examples, the width of a Super Beam assembly 16 may be less than or equal to a width of a battery cell 26, which allows a compact assembly of adjacent battery cells 26, 26′, etc.

In some examples, the top and/or bottom TMP suppression channels 138 and 139 may be made of a low-thermal conductivity ceramic material (e.g., alumina, silicon carbide, or silicon nitride). Alternatively, TMP suppression channels 138 and/or 139 may be made of a fiber-reinforced plastic (FRP) composite material, which has a low thermal conductivity and high strength/weight ratio. The FRP composite material may have fibers that are primarily oriented in the longitudinal (X-direction), e.g., a 1-D FRP.

What is claimed is:

1. A multi-function, integrated beam assembly with integrated structural, cooling, and transverse elastic compliance functions, comprising:
(a) a left face plate;
(b) a right face plate;
(c) one or more left coolant channel cover plates;
(d) one or more right coolant channel cover plates;
(e) one or more left coolant channels, defined by the left face plate and one or more left coolant channel cover plates; and
(f) one or more right coolant channels, defined by the right face plate and by the one or more right coolant channel cover plates;
wherein the one or more left coolant channel cover plates are attached to the left face plate;
wherein the one or more right coolant channel cover plates are attached to the right face plate; and
wherein the left face plate is oriented parallel to the right face plate.

2. The multi-function, integrated beam assembly of claim 1, further comprising:
a left coolant inlet disposed at a proximal end of the left face plate;
a left coolant outlet disposed at a distal end of the left face plate;
a right coolant inlet disposed at a proximal end of the right face plate; and
a right coolant outlet disposed at a distal end of the right face plate.

3. The multi-function, integrated beam assembly of claim 1,
wherein the one or more left coolant channels have a C-shaped cross-section; and
wherein the one or more right coolant channels have a C-shaped cross-section.

4. The multi-function, integrated beam assembly of claim 1, further comprising:
a left battery cell disposed adjacent to the left face plate; and
a right battery cell disposed adjacent to the right face plate.

5. The multi-function, integrated beam assembly of claim 4, further comprising:
a left Thermal Interface Material (TIM) disposed in-between the left battery cell and the left face plate; and
a right Thermal Interface Material (TIM) disposed in-between the right battery cell and the right face plate.

6. The multi-function, integrated beam assembly of claim 1, further comprising a top structural channel that is attached to the left face plate and to the right face plate.

7. The multi-function, integrated beam assembly of claim 6, wherein the top structural channel is attached to an upper left extension of the left face plate; and is attached to an upper right extension of the right face plate.

8. The multi-function, integrated beam assembly of claim 6, wherein the top structural channel has a T-shaped or M-shaped cross-section.

9. The multi-function, integrated beam assembly of claim 6, further comprising:
an upper left flange integrally attached to the left face plate; and
an upper right flange integrally attached to the right face plate;
wherein the top structural channel is attached to the upper left flange and the upper right flange.

10. The multi-function, integrated beam assembly of claim 9,
wherein the top structural channel is adhesively attached to the left upper flange with a left adhesive strip; and
wherein the top structural channel is adhesively attached to the right upper flange with a right adhesive strip.

11. The multi-function, integrated beam assembly of claim 1, further comprising a bottom structural channel that is attached to the left face plate and to the right face plate.

12. The multi-function, integrated beam assembly of claim 11, wherein the bottom structural channel has an I-shaped cross-section.

13. The multi-function, integrated beam assembly of claim 1,
wherein a left bottom portion of the left face plate has a Zig-Zag shaped cross-section; and
wherein a right bottom portion of the right face plate has a Zig-Zag shaped cross-section.

14. The multi-function, integrated beam assembly of claim 1, further comprising:
one or more upper air gaps disposed in-between the left face plate and the right face plate; and
one or more lower air gaps disposed in-between the left face plate and the right face plate.

15. The multi-function, integrated beam assembly of claim 6, wherein the top structural channel has a width that is less than or equal to a width of a battery cell.

16. The multi-function, integrated beam assembly of claim 11, wherein the bottom structural channel has a width that is less than or equal to a width of a battery cell.

17. A multi-function, integrated beam assembly with integrated structural, cooling, and transverse elastic compliance functions, comprising:
(a) a left face plate;
(b) a right face plate;
(c) one or more left coolant channel cover plates;
(d) one or more right coolant channel cover plates;
(e) one or more left coolant channels, defined by the left face plate and the one or more left coolant channel cover plates;
(f) one or more right coolant channels, defined by the right face plate and by the one or more right coolant channel cover plates;
(g) a top Thermal Management Propagation (TMP) suppression channel attached to a top portion of the Super Beam assembly; and
(h) a bottom TMP suppression channel attached to a bottom portion of the Super Beam assembly; and
wherein the left face plate is oriented parallel to the right face plate.

18. The multi-function, integrated beam assembly of claim 17, further comprising:
a left upper flange integrally attached to the left face plate;
a right upper flange integrally attached to the right face plate;
a left lower flange integrally attached to the left face plate;
a right lower flange integrally attached to the right face plate;
a left upper thermal fuse disposed between the top TMP suppression channel and the left upper flange;
a right upper thermal fuse disposed between the top TMP suppression channel and the right upper flange;
a left lower thermal fuse disposed between the bottom TMP suppression channel and the left lower flange; and
a right lower thermal fuse disposed between the bottom TMP suppression channel and the right lower flange.

19. The multi-function, integrated beam assembly of claim 17,
wherein the top TMP suppression channel comprises one or more upper Z-fold bellows segments; and
wherein the bottom TMP suppression channel comprises one or more lower Z-fold bellows segments.

20. An electric vehicle, comprising:
an electric motor vehicle body;
a battery pack connected to the electric motor vehicle body; and
one or more multi-function, integrated beam assemblies disposed inside of the battery pack, wherein each multi-function, integrated beam assembly comprises:
(a) a left face plate;
(b) a right face plate;
(c) one or more left coolant channel cover plates;
(d) one or more right coolant channel cover plates;
(e) one or more left coolant channels, defined by the left face plate and by the one or more left coolant channel cover plates; and
(f) one or more right coolant channels, defined by the right face plate and by the one or more right coolant channel cover plates; and
wherein the left face plate is oriented parallel to the left face plate.
